(19) United States
(12) Patent Application Publication
(10) Pub. No.: US 2025/0374879 A1
(43) Pub. Date: Dec. 11, 2025

(54) Intelligent Agriculture System Incorporating Waste and Rainwater Recycling for Vertical Farming

(71) Applicants: Abhishek Sharma, Jaipur (IN); Abdullah Alsaleh, Majmaah (SA); Sunil Kumar Sharma, Majmaah (SA)

(72) Inventors: Abhishek Sharma, Jaipur (IN); Abdullah Alsaleh, Majmaah (SA); Sunil Kumar Sharma, Majmaah (SA)

(21) Appl. No.: 19/010,550

(22) Filed: Jan. 6, 2025

(51) Int. Cl. A01G 31/06; A01G 3/00; A01G 13/21; A01G 31/00; A01G 31/02; B01D 61/14; B01D 69/14; B01J 21/06; B01J 35/39; B01J 35/59; B25J 9/00; B25J 9/16; C02F 1/00; C02F 1/32; C02F 1/44; C02F 1/66; C02F 1/68; C02F 1/72; C02F 3/00; C02F 3/28; C02F 9/00; C02F 101/10; C02F 101/16; C02F 101/30; C02F 103/00; C02F 103/26; F03B 17/06; G05B 13/02; G05D 7/06

(52) U.S. Cl. CPC A01G 31/06; A01G 31/011; A01G 31/0231; A01G 31/065; B01D 61/145; B01D 69/145; B01J 21/063; B01J 35/39; B01J 35/59; B25J 9/0006; B25J 9/1638; B25J 9/1679; C02F 1/008; C02F 3/006; C02F 9/00; F03B 17/061; G05B 13/027; G05D 7/0635; A01G 3/00; A01G 13/21; C02F 1/001; C02F 1/32; C02F 1/444; C02F 1/66; C02F 1/68; C02F 1/725; C02F 3/2853; C02F 2101/105; C02F 2101/16; C02F 2101/30; C02F 2103/001; C02F 2103/26; C02F 2201/3222; C02F 2209/03; C02F 2209/06; C02F 2303/04; C02F 2305/10

(57) ABSTRACT

The present invention relates to a modular and scalable system for intelligent vertical farming infrastructure, using the latest in water recycling sciences, and artificial-intelligence based automation. This helps to combat the issue of sustainable Agriculture+its minimizing usage of water, energy, and space. It combines a vertical farming structure with multiple levels of cultivation with an irrigation and drainage system to achieve recirculation of water. The water recycling unit consists of rainwater harvesting, wastewater collection and multi-stage treatment subsystems, which can guarantee a continuous supply of high-quality recycled water for irrigation. The invention also combines a network of Internet of Things (IoT)-enabled sensors and AI-based control circuitry to track and manage environmental conditions (e.g. light intensity, humidity, temperature, and nutrient levels).

### FIELD OF THE INVENTION

The field is agriculture, specifically, a rainwater and waste water recycling plant device and method for integration with vertical farming systems.

### BACKGROUND OF THE INVENTION

Vertical farming has a great potential, as it allows growing large-scale crops in close surroundings such as cities. But there is still a long way to go for its wider adoption due to major challenges including efficient water utilization, resource optimization and seamless system integration. Water recycling technologies often are not integrated in such systems nor do they lend themselves to a single solution to monitor and optimize the farming operation.

Traditional system of vertical farming to grow crops is primarily dependent on hydroponics, aeroponics, or aquaponics. Hydroponics which is growing plants in nutrient rich water solutions with no soil has been adopted widely due to its simplicity and water conservation. Aeroponics, in contrast, sprays nutrients directly at the plant roots in a fog, providing richer oxygen access and a quicker-growing plant. Giving fish waste to plants and the plants for the water is called Aquaponics, as it combines fish farming with hydroponics in a mutually dependent structure. Though these systems have shown promise in the reduction of water use and optimal crop yields, they possess inherent disadvantages.

Water management is one of the biggest challenges of traditional vertical farming systems. While these types of growing systems use a fraction of the water that soil-based farming does, they are not immune to waste. More factories need larger and larger amounts of water, especially because these systems often depend on continuous, regular flows of fresher water to keep up with the nutrient solutions. Also the nutrient solutions used in these systems can become imbalanced or contaminated over time and need to be periodcially flushed and replaced. In turn, this leads to higher water usage, producing not only wastewater loaded with leftover nutrients and chemicals, but also wastewater that can be an environmental issue if not managed through proper treatment.

The other concern is significant energy consumption in vertical farming systems. Vertical farming is energy-intensive, especially in areas with little renewable energy access, as it relies on artificial lighting, climate control and water circulation systems. Although new LED lighting technologies consume much less energy, their operating costs are still a huge obstacle for mass deployment. Moreover, most of the current vertical farming systems do not have any integrated energy recovery systems, resulting in metabolic inefficiencies and additional cost burden.

Challenges also lie in the monitoring and management of vertical farming operations. For example, traditional systems often use basic sensors for parameters like temperature, humidity, and nutrient levels. T3—Clearly these sensor models can provide a lot of information, but they go unused is because they do not act in unison, nor in a way that they provide automated actionable results. Farmers are forced to rely on manual intervention, or pre-programmed schedules to cater to irrigation, lighting and ventilation, which can result in less-than-optimal growing conditions and lower crop yields. Also, farmers cannot make best use of the resources, avoid the crop disease, and respond to changing environmental conditions because of the lack of advanced analytics and predictive tools.

A further limitation of the current vertical farming solutions is their inability to cover the complete issue of water recycling. Although there are systems with primary filtration and recirculation mechanisms, their simplicity does not provide sufficient purification of wastewater for later use. This is especially an issue in urban areas where water quality varies widely and clean water is not readily available. Vertical farming systems do not implement advanced water treatment technologies, resulting in water loss and reduced sustainability of these systems.

Additionally, most vertical farming technologies are not properly integrated with digitalization tools such as Internet of Things (IOT) and Artificial Intelligence (AI). Some systems have started integrating the Internet of Things (IoT) sensors to observe environmental aspects, though such applications are generally piecemeal and do not harness the complete capacity of connected devices. With no overarching platform for data collection and analysis, farmers are left to their own devices when it comes to making decisions to optimize their practices. Like vertical farming itself, the use of AI in the field is still very new, with most systems currently only using standard, basic algorithms in a way that doesn't come close to capitalizing on the potential benefits of machine learning and predictive analytics. This hinder the farmers not being able to predict crop growth, manage risks and enhance overall efficiency.

There is also the economic side of the coin that limits current vertical forms. Many farmers are not able to afford vertical farming systems due to their high up-front capital cost and continual investments in energy, maintenance, and labor. This is especially the case for small-scale farmers and those in developing areas, where funding and technological know-how are not widely available. The divide between being able to deploy at a commercial scale, with a high-roi application, vs a low-roi application affordable at community scale is a major challenge, with no real affordable scalable solution.

Vertical farming systems also involve the application of synthetic fertilizers and pesticides, raising environmental concerns. Although these inputs are frequently needed to optimize growing conditions, their over-application can result in nutrient imbalances, soil degradation (in hybrid systems), and water contamination. Similarly, Controlled Environments lack natural ecosystems, meaning that vertical farming systems are heavily reliant on human intervention to prevent pests and diseases, with the increasing potential for pesticide overuse and damage to the environment.

With these obstacles, there is certainly a demand for newer technology that overcomes the pitfalls of conventional vertical farming systems. Among them, systems providing water recycling and treatment technologies will be in high demand due to their ability to ensure a sustainable water supply with as much zero waste generation as possible. IoT and AI are advanced tools that can be utilized in farming where farmers need monitoring for real-time, predictive analytics and automated control in order to optimize resource usage and maximize crop yields. Moreover, the invention of modular and inexpensive systems can render vertical farming capable for smallholders and urban society.

### SUMMARY OF THE INVENTION

The present invention relates to a a smart vertical farm system and device that combines water reuse, IoT-based logging, and AI-based automation in one compact machinery. This technology combines vertical farming with a water treatment solution that treats rain and agricultural waste for reuse. This system is integrated with IoT sensors, AI-based control prior, and smart applications making this system capable of monitoring, predictive analytics, and automated control of farming operations in real-time.

The invention's key features are modular construction for the scalability of use, an integrated software platform that enables remote monitoring of all the greenhouses, and decision-making driven by AI that predicts crop growth and optimizes inputs as required. This modern device guarantees the perfect combination of resource-saving water usage with careful farming, specifically designed for urban farming or any limited farming. The uptake of geospatial precision agriculture is rapidly accelerating in vertical farming and other constrained agricultural systems.

The invention provides an automated vertical farming system that converges water recycling technology, IoT, and AI for a sustainable farming solution in one package. Urban and semi-urban farming have become a primary focus in today's environment dominated by water scarcity, land scarcity, and inefficient resource utilization. The invention aims to optimize water utilization, improve crop efficiency, and lower the carbon footprint in vertical farming systems by integrating rainwater harvesting, wastewater treatment, and smart farming technologies in a single device.

The aim of the present invention is to provide a modular, scalable structure for vertical farming, which can be locally deployed to address a variety of spatial and operational requirements. Typical commercial scale development facilities have multiple layers of cultivation trays, with advanced irrigation systems that distribute treated water. By integrating IoT-enabled sensors, the system can monitor key parameters in real-time including soil moisture, nutrient level, light intensity, and ambient conditions. Such real-time monitoring ability enables users to ensure that growing conditions are optimal and avoids wasting resources.

Another set goal is the addition of complete water recycling and treatment system to the vertical farming set up. Using advanced filtration and sterilization techniques, this unit is designed to treat rainwater and wastewater produced during farming processes. This treated water is then used again in the system itself, which means that it is a closed-loop, water-saving system that minimizes both water usage in general and reliance on outside water supplies. Using the recycled water for sensitive crops reduces the risks in terms of phytotoxicity and pathogen exposure, as the invention improves the safety and quality of the recycled water.

Potential application of AI in solutions based on vertical farming patent considerations these algorithms use IoT sensors data to deliver predictive insights on crop growth cycles, resource requirements and potential threats to the crop. The application of machine learning models to determine the best irrigation schedules, nutrient delivery, and environmental control for maximum efficiency and productivity allows the system to meet its goals efficiently. The AI component also encompasses risk management features, enabling the system to anticipate and alert users to potential problems like pest infestations, nutrient imbalances, or equipment malfunctions.

In addition, a smart application interface is provided to improve usability and control of the system for the user. This mobile and web app offers real-time updates, analytics, and remote control capabilities. Through this feature, users will be able to monitor and manage the vertical farming system from any location, enabling increased convenience and operational flexibility. It also includes forecasting and data visualization tools to help users make informed decisions based on historical and real-time data.

Another object of the invention is to provide for energy efficiency and sustainability in vertical farming. The invention reduces energy consumption of the farming operation in general by implementing energy recovery mechanisms and by optimizing the artificial lighting and climatization systems usage therein. Urban environments can be especially cost-prohibitive for energy use and inputs for renewable energy sources may not exist. With additional details highlighting the use of sustainable materials and technologies through the design and construction process.

Ultimately, this invention will allow for more affordable and practical vertical farming for more types of consumers such as small farmers, urban farmers, and commercial operators. From a technical perspective, the system is modularly designed and we use inexpensive components that helps reduce the upfront investment to deploy the system. This leads to lower operational costs through intelligent automation, reducing labor and resource inputs. Increasing the availability and decreasing the cost of the technology can help in bridging the gap by making it a global citizen's choice as well as entrepreneur's choice.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of an intelligent vertical farming system;

FIG. 2 provides an illustration of in-house reusability and hydroponic farming facility;

FIG. 3 illustrates a network diagram in accordance with the present invention;

FIG. 4 illustrates a workflow diagram of intelligent vertical farming system;

FIG. 5 illustrates a block diagram of an intelligent agriculture system incorporating waste and rainwater recycling for vertical farming; and

FIG. 6 illustrates a flow chart of a method for operating an intelligent agriculture system incorporating waste and rainwater recycling for vertical farming.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

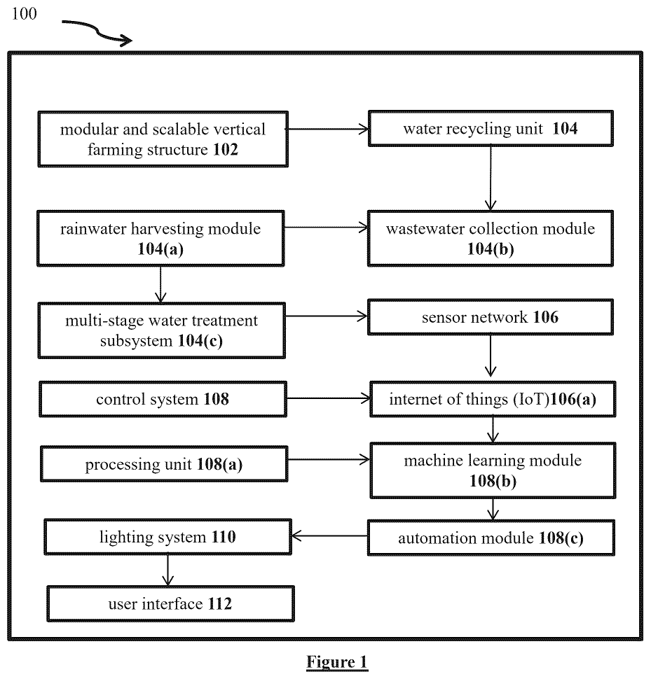

Referring to FIG. 1, a block diagram of an intelligent vertical farming system comprising: an intelligent vertical farming system comprising: a modular and scalable vertical farming structure 102 designed to accommodate multiple cultivation layers, each equipped with irrigation channels and drainage systems for water recirculation; a water recycling unit 104 integrated with the vertical farming structure, the unit comprising: a rainwater harvesting module 104(a) including collection surfaces, pre-filtration mechanisms, and insulated storage reservoirs for maintaining water quality; a wastewater collection module 104(b) featuring automated valves and quality monitoring sensors for measuring water metrics such as turbidity and pH; and a multi-stage water treatment subsystem 104(c) employing sedimentation, bio-filtration, and ultraviolet sterilization technologies to ensure treated water is suitable for reuse in irrigation; a sensor network 106 comprising Internet of Things (IoT)-enabled devices 106(a) configured to monitor real-time parameters, including soil moisture, nutrient levels, light intensity, ambient temperature, and humidity; a control system 108 incorporating: an Artificial Intelligence (AI)-based processing unit 108(a) programmed to analyze sensor data, generate crop growth predictions, and optimize system parameters; a machine learning module 108(b) trained on historical and real-time data to enhance resource allocation strategies; and an automation module 108(c) configured to dynamically adjust environmental controls, including lighting, irrigation, and ventilation, based on AI-generated recommendations; a lighting system 110 comprising energy-efficient LED 110(a) fixtures with adjustable spectral outputs, integrated with the control system for automated intensity and photoperiod regulation; and a user interface 112 accessible via mobile and web platforms, enabling real-time monitoring, data analytics, and remote control of system operations.

In an embodiment, the rainwater harvesting module 104(a) includes a filtration assembly comprising a dual-layer coarse and fine filter to remove debris and particulates, and a temperature-controlled reservoir that prevents microbial proliferation by maintaining water at a predefined optimal range.

In an embodiment, the wastewater collection module 104(b) incorporates a sensor array configured to measure turbidity, pH levels, and dissolved oxygen content of the collected water, wherein the sensor data is transmitted to the AI-based processing unit for dynamic adjustment of the water treatment parameters.

In an embodiment, the multi-stage water treatment subsystem 104(c) employs adaptive filtration mechanisms controlled by the AI-based processing unit, such that filtration and sterilization stages adjust flow rates and treatment intensities based on the quality and volume of the incoming water.

In an embodiment, the IoT-enabled sensor 106(a) network includes: a) root-zone sensors embedded within cultivation trays to monitor localized nutrient levels and electrical conductivity; b) multi-spectral imaging devices for detecting crop health anomalies, such as stress or early signs of disease, by analyzing reflected light spectra; and c) atmospheric sensors distributed across cultivation layers to measure microclimatic variations in temperature, carbon dioxide concentration, and airflow.

In an embodiment, the AI-based processing unit 108(a) is configured to execute real-time anomaly detection algorithms that compare sensor data against predefined thresholds, trigger automated system adjustments, and generate alerts for user intervention when anomalies exceed predefined tolerance levels.

In an embodiment, the lighting system 108(d) integrates a multi-channel LED array capable of emitting variable spectra, wherein the spectrum, intensity, and duration of light are dynamically adjusted by the control system to optimize photosynthetic efficiency for different crop growth stages.

In an embodiment, the user interface 112 includes a predictive analytics module powered by the AI-based processing unit, the module being configured to forecast crop yields, recommend planting schedules, and provide insights into resource utilization trends, based on historical and real-time data.

In an embodiment, the modular vertical farming structure 102 includes detachable cultivation trays constructed from food-grade, UV-stabilized materials with integrated drainage and aeration systems, the trays being designed for rapid assembly, disassembly, and reconfiguration to accommodate different crop types.

In an embodiment, the automation module 108(c) is further configured with a failsafe mechanism that monitors critical system operations, such as power supply, water circulation, and environmental controls, and automatically initiates contingency protocols to prevent system failure or crop damage during operational anomalies.

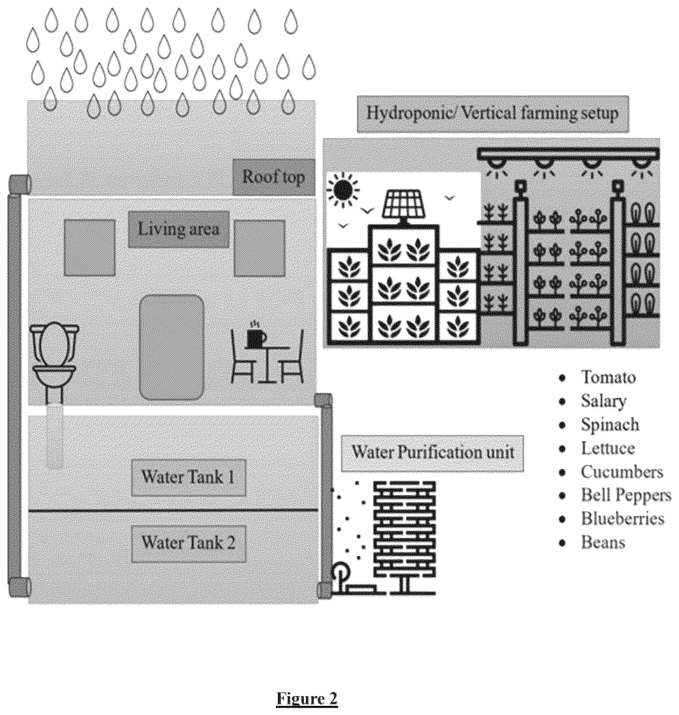

FIG. 2 provides an illustration of in-house reusability and hydroponic farming facility.

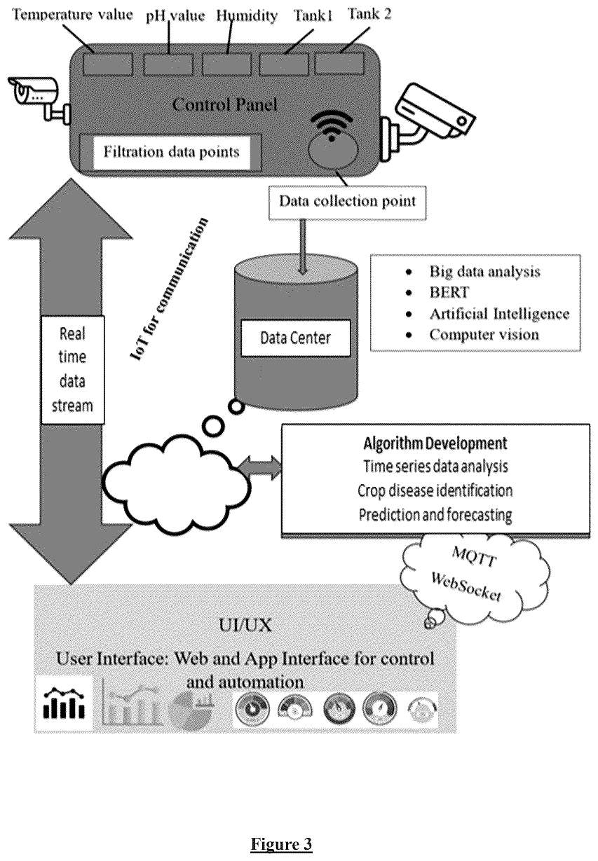

FIG. 3 illustrates a network diagram in accordance with the present invention.

Vertical farming tower is a multilayered cultivation skeleton for effective use of space. An extensive structure with multiple trays for hydroponic or soil-based cultivation, incorporated irrigation channels for uniform water distribution. The tower is fitted with LED grow lights and temperature control systems to provide optimal growing conditions.

The base of the tower contains a water recycling unit. It collects and treats rainwater and wastewater generated during farming activities. It uses sedimentation, UV sterilization, and bio-filtration to treat the water for reuse. Ebro is stored in an insulated reservoir, which provides a steady stream of water when desiccation is in the forecast.

Referring to FIG. 3, the intelligent control system forms the core of the invention. The system is equipped with IoT-based sensors placed in various locations throughout the device to monitor parameters like soil moisture, nutrient levels, light intensity, and ambient temperature. The information collected by the sensors is then transmitted to a central processing unit, which uses artificial intelligence to analyze data and determine actionable insights. The AI system also predicts how crops will grow, detects abnormalities, and optimizes irrigation, lighting, and ventilation.

The device communicates with a cloud-based software platform, which enables users to remotely monitor and control the system through mobile and web applications. It provides real-time alerts, data visualization, and forecasting capabilities. Additionally, it helps manage risks by alerting against potential disasters like pest attacks and water shortages, and suggesting mitigation strategies.

The operation starts with the harvesting of rainwater and collection of wastewater. This water is processed by the water recycling unit, and its quality meets the irrigation standard. Treating this water through a separate process and distributing it through the irrigation system, helps maintain proper moisture levels in the farming trays. IoT sensors collect real-time data from the tower and send it to the AI-powered control to analyze it. It autonomously modifies farming conditions such as lightness, nutrients, temperature and other critical factors to ensure the devise helps grow a healthy crop with the analysis done. The device can be controlled by users through the mobile application that provides real-time updates, analytics and remote-control options.

The present invention is of a sustainable approach to a modern agriculture system. Incorporating a water recycling system in the vertical farming vertical farming integrates is added a value that reduces resource wastage and helps to resolve the water scarcity problem. Its modular structure and intelligent control system allow for easy application and potential in varying agricultural settings. The unified software platform enhances user experience, offering seamless automation, predictive insights, and risk management tools.

The invention is well-suited for urban farming, where land and water resources are scarce. In addition, it could be implemented in semi-arid and arid areas as a sustainable method of agricultural water use. Its modular nature allows the technology to scale up for indoor garden use, or down for commercial farm production.

The process starts with the collection of rainwater and wastewater. This water is recycled through the water quality unit so quality standards are met for irrigation. The recycled water is delivered via the irrigation system, which keeps the farming trays moist. IoT sensors are attached to the tower collecting data in real-time and transferred to the AI control system for analytics. The system then self-adjusts farming parameters such as light intensity, nutrient delivery and temperature based on the analysis, to facilitate healthy crop growth. A mobile application allows users to send and receive real-time status updates, analytics, and remote-control commands to the device.

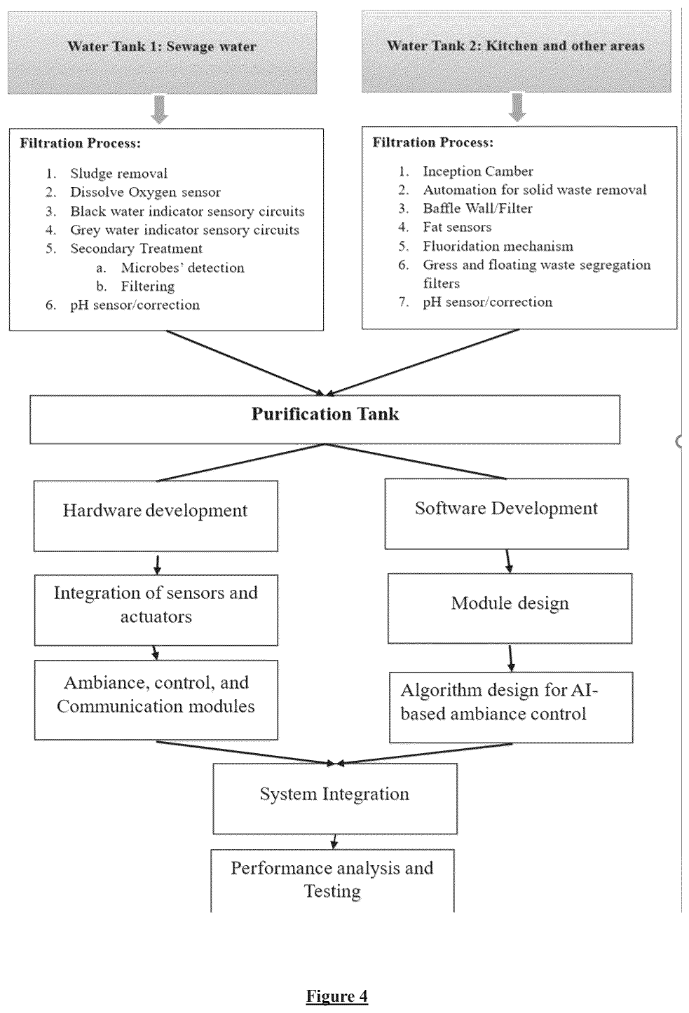

FIG. 4 illustrates a workflow diagram of intelligent vertical farming system.

Referring to FIG. 4, a workflow for an intelligent agricultural system designed for vertical farming, focusing on water filtration, purification, and system integration, is represented. The system begins with two primary water sources. The first is sewage water stored in Water Tank 1, where filtration process includes sludge removal, and secondary treatment for microbe detection and filtering, wherein the components used are dissolve oxygen sensor, black and gray water indicator sensory circuits, and pH sensor for correction. The second source of water is kitchen and general wastewater stored in Water Tank 2, where for filtration components namely inception chamber, baffle wall/filter, fat sensors, fluoridation mechanism, gress and floating waste segregation filters, and pH correction sensors are used.

Both treated water streams from the tanks are directed into a centralized purification tank for further processing. This purified water is intended to support the irrigation needs of vertical farming systems. To achieve this, the system integrates both hardware and software components. The hardware development phase focuses on incorporating sensors and actuators, along with modules for environmental control and communication. Meanwhile, the software development phase is dedicated to designing modules and algorithms, particularly for AI-based control mechanisms, which aim to optimize the system's ambiance and operational efficiency. Once the hardware and software components are developed, they are integrated into a unified system.

The system is subjected to performance analysis and testing to ensure that the system operates seamlessly and delivers reliable results. The overall design and functionality of this system highlight its potential for sustainable water management and efficient resource utilization in vertical farming, providing an intelligent solution to modern agricultural challenges.

The present invention relates to an intelligent agricultural system for vertical farming, designed to incorporate waste and rainwater recycling to enhance sustainability and optimize crop productivity. The system comprises a modular mechanical framework configured for vertical assembly, featuring a load-bearing exoskeleton with beams containing integrated micro-channels for the transport of nutrient solutions and irrigation water. This configuration ensures efficient fluid delivery to crops while maintaining structural integrity through piezoelectric sensors embedded in the framework. These sensors monitor dynamic strain during loading conditions and relay data to an automated control system that adjusts beam alignment for stability. The framework also includes a retractable rail system, facilitating automated maintenance and harvesting via a mobile platform supporting robotic and manual tools.

The system incorporates a multi-layered stacked cultivation system that maximizes vertical space and enables uniform distribution of water, nutrients, and light across each layer. The system includes a dual-channel nutrient delivery mechanism, comprising a capillary-driven wick layer for moisture distribution and a pressurized irrigation manifold with micro-diffusers that precisely deliver water to plant root zones. The cultivation system also features an adaptive canopy adjustment mechanism, employing servo motors and tilt sensors to dynamically alter the angles of growing trays based on light intensity. This ensures optimal light exposure and photosynthesis, adjusting according to real-time data from light sensors and plant growth indicators.

A key aspect of the system is its integrated waste and rainwater recycling subsystem. It includes a hybrid rainwater collection and filtration system using an ultrafiltration membrane with photocatalytic sterilization, and a waste processing reactor that employs anaerobic digestion followed by a membrane bioreactor (MBR) to recover nutrient compounds. These compounds are then recycled into the irrigation system to nourish plants. The system's autonomous monitoring and actuation system includes distributed microelectromechanical systems (MEMS) sensors to measure environmental parameters, such as nutrient concentrations and fluid flow, which feed data into a mechanical actuation subsystem. This subsystem includes robotic precision nozzles for micro-mist irrigation and a gantry-mounted robotic arm for autonomous crop inspection, pruning, and maintenance.

To enhance scalability and integration, the system includes a modular mechanical docking interface with a quick-lock mechanism that uses pneumatically actuated seals to ensure leak-proof hydraulic connections between modules. The rotary coupling in the system incorporates micro-turbines that convert excess water flow into energy, reducing operational costs. Additionally, the modular power management and control unit features a regenerative braking system to recover kinetic energy from moving components and a localized decision-making controller that employs edge AI processors for real-time predictive analytics, optimizing resource management and system operations.

The system also incorporates feedback loops to dynamically adjust nutrient and irrigation delivery based on real-time sensor data. For instance, when moisture levels fall below optimal thresholds, the capillary wick layer activates, and pressurized micro-diffusers are triggered to deliver nutrient-enriched recycled water. The integration of sensors in the nutrient delivery system ensures that each platform's moisture and nutrient levels are maintained for optimal growth. Excess mist from the micro-mist irrigation is recaptured through a condensation system, further promoting water efficiency.

The innovation of the modular mechanical framework extends to adjustable tensioning cables within the beams that actively adjust load distribution based on detected strain, enhancing the system's resilience to external forces. The automated control system continuously recalculates the most efficient irrigation and nutrient distribution paths using spatial data from machine vision and LiDAR sensors, ensuring that each plant receives the correct amount of moisture and nutrients for optimal growth. Furthermore, the localized AI-based decision-making controller continuously monitors various environmental and operational parameters, ensuring that crop health is maintained and that system faults, such as pump failures or clogging, are detected early.

The present invention provides a fully automated, scalable, and sustainable solution for vertical farming, where waste and rainwater are efficiently recycled, ensuring resource conservation and optimal plant growth across various cultivation layers.

This invention provides a sustainable and effective solution for the challenges of modern agriculture. Vertical farming in this case not only reduces unnecessary resource wastage, but also is used to solve the problem of water scarcity through water recycling. This modular structure enables ease of use as well as scalability and adaptability in various agricultural contexts along with an intelligent control system. This unified software platform improves the user experience by providing workflows, predictive insights, and risk management tools.

The invention is especially ideal for urban farming where space and water resources are degraded. It can even be used in semi-arid and fully arid regions, sustainable agricultural water management solution. Its modular design allows it to be used for both small-scale indoor gardens and large-scale commercial farming operations.

This intelligent vertical farming system combines advanced modular farming infrastructure with the latest in water recycling and artificial intelligence (AI) technology. This combination provides a novel solution to sustainable farming in small areas while maximizing resource utilization and crop yields.

The vertical farming system has a modular and scalable design that allows for the addition of several layers of cultivation. In-house, each layer is outfitted for calibration with intricately engineered irrigation channels for uniform water delivery, as well as drainage systems for efficient water recirculation. These structures are made with sturdy, UV-resistant, food-grade materials for longevity. The integration of the irrigation and drainage systems directs excess water to the integrated water recycling unit, reducing water wastage.

The water recycling unit consists of three key components: a rainwater harvesting module, a wastewater collection module, and a multi-stage water treatment subsystem. Rainwater harvesting module with customized collection surfaces and pre-filtration systems that helps filter out debris the harvested rainwater is kept in insulated stores units that create good quality environmental conditions, thereby preventing microbial growth. The wastewater collection module is equipped with automated valves and quality monitoring sensors that measure turbidity, pH, and dissolved oxygen levels. The treatment subsystem consists of technologies for sedimentation, bio-filtration, and ultraviolet sterilization through which excess irrigation water is sent. The multi-stage treatment process ensures that recycled water is treated to exacting standards before being reused for irrigation purposes, thus conserving resources and maintaining ecological balance.

The intelligence of the system is based on an extensive array of IoT connected sensors underpinned by a high-level control system. Strategic placement of IoT devices are present throughout the farming structure and water recycling unit to monitor the key parameters across the system in real-time. These sensors collect data on soil moisture, nutrient levels, light intensity, ambient temperature, and humidity, creating a stream of inputs to the control system.

It utilizes an AI-based processing unit with advanced algorithms for sensor data analysis. It improves the ability to predict by allocating the data used to train machine learning models on both historical data and real-time data. In one example, these models predict crop growth trends by using environmental input data to optimize irrigation, nutrient delivery and ambient parameters. Anomaly detection algorithms are used to detect any anomalies (like a nutrient deficiency, pest infestation, and water quality deviation) from the expected behaviour/movement. These algorithms continuously contrast incoming sensor data with established thresholds to initiate corrective actions autonomously.

The control system's automation module implements dynamic environmental controls like lighting, irrigation and ventilation. Namely, the lighting system consists of eco-friendly LED units, with tunable spectral compositions. These LEDs are connected to the control system which adjusts light intensity and photoperiod according to plant demands. Data from soil moisture sensors helps automate the irrigation process by refining irrigation schedules and providing water only when required, minimizing wastage. In a similar way, settings for the ventilation and the temperature are optimized to create the microclimate for the growth of the crops.

They are long-tail algorithms oriented around iterative learning. A possibility include the use of a reinforcement learning method to improve the operation of water recycling where AI analyzes the effectiveness of treatment in real time and modifies filtration parameters accordingly. Convolutional neural networks (CNNs) process multi-spectral imaging data in order to identify initial symptoms of crop stress or disease and furnish actionable insights for both detection and preventative action.

Remote monitoring and management of the system is also possible through a simple user interface that can be accessed from a mobile or web client. In this interface, real-time data visualization, predictive analytics, and alerts within the system are displayed. Users can access comprehensive growth projections, resource usage patterns, and past performance indicators, for instance. Alerts alert users to critical issues (for example, pest outbreaks or equipment malfunctions) that require immediate intervention. The interface also allows for a multiuser mode with rolebased permissions to ensure collabourative management whilst keeping data secure.

The system also includes a risk management module, which assesses potential threats like water rationing or environmental fluctuations. The module triggers risk predictions and mitigation strategies by analyzing historical patterns and real-time inputs. Automated responses are then triggered to mitigate immediate threats, including redistributing water during droughts or activating pest deterrent systems.

The smart vertical farming system provides a complete and sustainable agricultural solution based on modular infrastructure, advanced water recycling technology, and artificial intelligence automation technology. Addressing the challenges of modern farming with precision and efficiency, their integration ensures optimal resource utilization, heightened productivity, and lessened environmental impact; all while leveraging the potentials of IOT and machine learning.

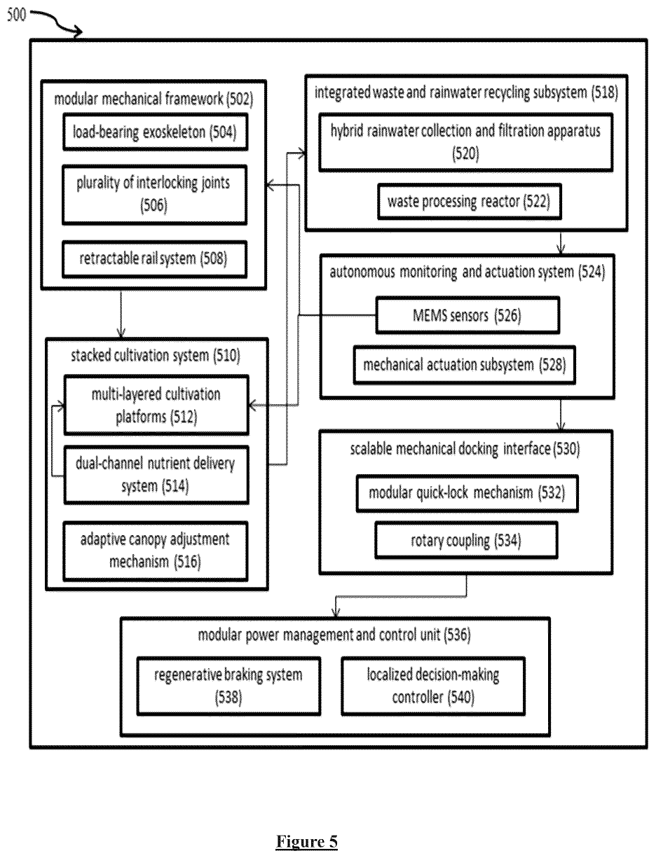

FIG. 5 illustrates a block diagram of an intelligent agriculture system (500) incorporating waste and rainwater recycling for vertical farming.

Referring to FIG. 5, the system (500) includes a modular mechanical framework (502) configured for vertical assembly, each module including: a load-bearing exoskeleton (504) formed having a plurality of beams with integrated micro-channels for internal fluid transport, wherein each beam includes integrated micro-channels for the internal transport of fluids, said micro-channels being capable of carrying nutrient solution or irrigation water to various points within the structure, enabling the efficient delivery of fluids to the crops housed within the module; a plurality of interlocking joints (506) positioned at key points of the exoskeleton (504), each joint embedding piezoelectric sensors that detect and measure structural strain during dynamic loading conditions, and wherein the piezoelectric sensors are connected to an automated control system that processes strain data in real-time and adjusts the positioning or alignment of the beams to compensate for dynamic forces, ensuring stability and structural integrity under varying operational loads; and a retractable rail system (508) integrated into the framework (502), said rail system (508) being automatically extendable along predefined tracks built into the beams, enabling efficient automated maintenance and harvesting operations by providing a mobile platform that supports robotic and manual tools for plant care, monitoring, and harvesting tasks. The system (500) further comprises a stacked cultivation system (510) comprising: multi-layered cultivation platforms (512), each designed for stacked configuration to maximize vertical space, wherein each platform (512) features a system of integrated channels designed to optimize water flow and prevent stagnation, with each layer acting as an independent cultivation unit capable of receiving uniform light, water, and nutrients through the system, ensuring each plant's root zone is consistently maintained with the optimal moisture levels; a dual-channel nutrient delivery system (514) within each platform (512), wherein the first channel is equipped with a capillary-driven wick layer that promotes uniform distribution of nutrients and moisture across the platform's surface, and wherein the second channel incorporates a pressurized irrigation manifold equipped with micro-diffusers strategically placed to precisely deliver recycled water directly to the root zones of plants; and an adaptive canopy adjustment mechanism (516) featuring servo-motor-driven panels with variable shading properties, configured to optimize photosynthetic photon flux density based on real-time crop requirements, wherein the canopy adjustment system (516) comprises a series of motorized actuators mechanically connected to the base of each growing tray, enabling the automatic adjustment of the tray angles to optimize light exposure across the crop canopy, wherein each growing tray is equipped with tilt sensors that detect the current angle and relay this data to the central control module, which calculates the optimal angle for each tray based on real-time data from light intensity sensors and plant growth indicators, and wherein the system adjusts the tray angle by tilting the trays in small incremental movements to ensure that the crops receive the correct light distribution depending on their growth stage and the intensity of light reaching the canopy. The system (500) further comprises an integrated waste and rainwater recycling subsystem (518), comprising: a hybrid rainwater collection and filtration apparatus (520) with an ultrafiltration membrane incorporating nanostructured titanium dioxide coatings for photocatalytic sterilization; and a waste processing reactor (522) involving anaerobic digestion followed by a membrane bioreactor (MBR) stage to recover and concentrate nutrient compounds, which are reintroduced into the irrigation system via an embedded nutrient dispensing unit. The system (500) further comprises an autonomous monitoring and actuation system (524), comprising: distributed microelectromechanical systems (MEMS) sensors (526) embedded within the cultivation platforms (512) and structural framework (502) to measure environmental parameters, including nutrient concentration gradients, fluid flow rates, and atmospheric CO₂ levels; and a mechanical actuation subsystem (528), including a plurality of robotic precision nozzles for micro-mist irrigation and a gantry-mounted robotic arm equipped with LiDAR and machine vision for autonomous pruning, crop inspection, and modular maintenance. The system (500) further comprises a scalable mechanical docking interface (530) for integrating multiple farming modules, wherein each module includes a modular quick-lock mechanism that utilizes pneumatically actuated seals to form leak-proof hydraulic connections between modules, comprising: a modular quick-lock mechanism (532) with pneumatically actuated seals to ensure leak-proof hydraulic connections between modules; and a rotary coupling (534) to generate auxiliary power from excess water flow, facilitating energy-efficient operation of subsystems. The system (500) further comprises a modular power management and control unit (536), comprising: a regenerative braking system (538) embedded within moving mechanical components, including canopy panels and robotic arms, to recover kinetic energy; and a localized decision-making controller (540) leveraging edge AI processors to enable predictive analytics for crop health and system maintenance, minimizing latency in autonomous operations.

The intelligent agriculture system incorporating waste and rainwater recycling for vertical farming provides a modular, scalable, and efficient solution for sustainable farming in urban or controlled environments. Each feature is designed to work harmoniously, ensuring the system's functionality and practicality.

The modular framework is designed to support vertical farming with a load-bearing exoskeleton. Each beam within the exoskeleton contains integrated micro-channels that facilitate internal fluid transport. These micro-channels allow nutrient solutions or irrigation water to be carried seamlessly from a central reservoir to various cultivation platforms housed within the structure. For instance, water from a rainwater collection unit can be channeled through these beams to reach each cultivation layer without requiring external piping, thereby minimizing spatial clutter and ensuring efficient fluid delivery.

The framework is stabilized using interlocking joints equipped with piezoelectric sensors. These sensors detect structural strain caused by dynamic loading conditions such as varying crop weights or environmental factors like wind. When strain is detected, the sensors relay data to an automated control system, which adjusts the alignment or positioning of the beams in real-time by activating motorized actuators. For example, if a section of the framework experiences an uneven load due to crop growth, the system can redistribute the load by shifting the position of specific beams, ensuring stability and operational safety.

An integrated retractable rail system, built into the framework's beams, provides automated maintenance and harvesting capabilities. The rails can extend along predefined tracks to support robotic systems or manual tools. For instance, a robotic arm can travel along these rails to prune plants, inspect crop health, or harvest produce. This feature reduces labor requirements and ensures uniform maintenance across the vertical farm.

The stacked cultivation system includes multi-layered platforms designed to maximize the use of vertical space. Each platform incorporates integrated channels that optimize water flow and prevent stagnation, ensuring a consistent supply of water to the crops. For example, water entering the platform flows through the channels, which are slightly inclined to promote gravity-assisted drainage, preventing pooling that could lead to root rot.

A dual-channel nutrient delivery system ensures precise irrigation. The first channel uses a capillary-driven wick layer that evenly distributes moisture and nutrients across the platform's surface. This layer acts as a sponge, drawing water from the integrated micro-channels and spreading it uniformly. The second channel employs a pressurized irrigation manifold with micro-diffusers that deliver recycled water directly to the root zones of plants. For instance, the manifold can be programmed to release water at intervals, maintaining optimal hydration levels for the crops while conserving resources.

The adaptive canopy adjustment mechanism features servo-motor-driven panels that regulate light exposure. Each growing tray is equipped with tilt sensors that measure its current angle. Data from these sensors, combined with readings from light intensity sensors, are processed by a central control module to calculate the optimal tray angle. For example, if the light source is too intense, the system tilts the trays slightly to reduce exposure, preventing leaf scorch and optimizing photosynthesis.

Rainwater collected from the system's environment is purified using an ultrafiltration membrane coated with nanostructured titanium dioxide. This coating facilitates photocatalytic sterilization, breaking down contaminants under UV light. The purified water is then stored in a reservoir and distributed through the micro-channels to the cultivation platforms.

The waste recycling subsystem processes organic waste using anaerobic digestion followed by a membrane bioreactor (MBR) stage. Anaerobic digestion breaks down organic matter to produce biogas and nutrient-rich slurry. The MBR stage filters this slurry to recover concentrated nutrients, which are then mixed with water and dispensed to the crops via the nutrient delivery system. For instance, vegetable trimmings from the farm can be recycled into the irrigation system, creating a closed-loop nutrient cycle.

Environmental parameters such as nutrient concentration, fluid flow rates, and CO₂ levels are monitored by distributed MEMS sensors embedded in the cultivation platforms and structural framework. These sensors continuously relay data to a central control unit, which analyzes the information and triggers appropriate responses. For instance, if CO₂ levels drop below the optimal range, the system can activate supplemental CO₂ injectors to enhance photosynthesis.

The mechanical actuation subsystem includes robotic precision nozzles for micro-mist irrigation. These nozzles spray fine droplets directly onto the plants, maintaining humidity levels and providing moisture without waterlogging. A gantry-mounted robotic arm equipped with LiDAR and machine vision autonomously prunes overgrown leaves, inspects crop health, and performs maintenance. For example, the robotic arm can identify pest infestations using machine vision and remove affected areas to prevent spread.

The modular quick-lock mechanism ensures seamless hydraulic and mechanical integration between farming modules. Pneumatically actuated seals provide leak-proof connections, allowing nutrient-rich water to flow from one module to another. For instance, as new modules are added to the vertical assembly, the quick-lock mechanism automatically aligns and secures them, maintaining fluid continuity.

The rotary coupling integrates micro-turbines that generate auxiliary power from excess water flow. As water moves through the coupling, it drives the micro-turbines, converting kinetic energy into electricity. This energy can be used to power sensors, actuators, or robotic systems, ensuring energy-efficient operation. For example, during irrigation cycles, excess water flow from the main channel spins the turbines, generating supplemental power for the system.

The power management system includes regenerative braking mechanisms within moving components such as the canopy panels and robotic arms. When these components decelerate, kinetic energy is captured and converted into electrical energy, which is stored for later use. For instance, as the robotic arm slows down during pruning, the regenerative braking system captures the energy and channels it into the system's power reserve.

By analyzing data from sensors and historical trends, the system can predict potential issues such as nutrient deficiencies or structural strain. For example, if the system detects a gradual decrease in nutrient levels, it can preemptively increase nutrient flow, preventing crop stress and maintaining productivity.

In an embodiment, the nutrient delivery system (514) is triggered by a feedback loop integrating MEMS sensors measuring real-time root-zone hydration levels and electrochemical nutrient concentration, initiating: a capillary-driven flow from the wick layer upon detection of moisture levels below a predefine optimal threshold; and a pressurized micro-diffuser activation through solenoid valves, dynamically calibrated to deliver nutrient-enriched recycled water in bursts proportional to plant absorption rates.

The nutrient delivery system operates based on a feedback loop that dynamically adjusts water and nutrient supply to ensure optimal plant growth conditions. This feedback loop integrates MEMS (microelectromechanical systems) sensors strategically placed within each cultivation platform to monitor root-zone hydration levels and nutrient concentrations.

The MEMS sensors provide continuous, real-time data on the moisture content in the soil or growing medium and the electrochemical composition of nutrients available to the plants. For example, the hydration sensors measure the dielectric properties of the growing medium, which correlate to its moisture level, while electrochemical sensors detect specific ions such as nitrates, phosphates, and potassium, critical for plant growth.

When the sensors detect that moisture levels have fallen below a predefined optimal threshold, the system initiates a capillary-driven flow from the wick layer embedded in the cultivation platform. The wick layer is designed to absorb and distribute water evenly across the platform's surface. This passive mechanism relies on the natural capillary action of the wick material, ensuring that water is uniformly available to the root zones without requiring energy-intensive pumping systems.

Simultaneously, if nutrient concentration data from the electrochemical sensors indicate a deficiency, the system activates a pressurized irrigation manifold equipped with micro-diffusers. These micro-diffusers are controlled by solenoid valves, which are dynamically calibrated to regulate the flow rate and duration of nutrient delivery. For instance, when a plant exhibits high nutrient absorption rates during its growth phase, the system increases the burst frequency and volume of nutrient-enriched recycled water through the diffusers, ensuring that the plants receive adequate nourishment.

The integration of MEMS sensors with the nutrient delivery system creates a closed feedback loop. This loop ensures precise, need-based irrigation and fertilization, preventing overwatering, nutrient leaching, and resource wastage. For example, during a dry period, the system may increase the frequency of capillary flow activation to maintain consistent hydration, while nutrient bursts from the micro-diffusers are adjusted to match the plants' metabolic needs, as indicated by sensor data.

In an embodiment, the anaerobic digestion stage is triggered by a volumetric sensor detecting organic waste accumulation exceeding 85% of the reactor's capacity, and the subsequent membrane bioreactor (MBR) is activated via a pressure differential sensor, ensuring immediate segregation of particulate matter larger than 10 microns; selective recovery of dissolved nitrogen, phosphorus, and potassium compounds; and automated redirection of concentrated nutrients to the dual-channel nutrient delivery system, and wherein the rainwater harvesting is triggered by piezoelectric sensors embedded in the collection surfaces, detecting rainfall intensity above 2 mm/hour and the ultrafiltration membrane activates a photo catalytic sterilization cycle powered by embedded UV-LED arrays when bacterial counts exceed 100 colony-forming units per millilitre.

In an embodiment, there are two distinct yet interlinked subsystems: an anaerobic digestion stage for organic waste processing and a rainwater harvesting and filtration system. Both subsystems are triggered by highly specialized sensors that respond to specific environmental conditions, ensuring efficient operation and resource optimization.

The anaerobic digestion system is designed to process organic waste generated within the vertical farming system, such as plant residues, soil matter, and other organic byproducts. The system is equipped with a volumetric sensor, which monitors the accumulation of organic material within the reactor. Once the sensor detects that the organic waste has reached 85% of the reactor's total capacity, the anaerobic digestion process is automatically initiated. This sensor ensures that the system can manage organic waste load efficiently, preventing overcapacity and ensuring continuous operation of the anaerobic digestion process.

Upon activation, the waste undergoes anaerobic digestion, wherein microorganisms break down the organic material in the absence of oxygen, producing biogas (mainly methane) and digestate. Following the digestion process, the reactor output moves into a membrane bioreactor (MBR) stage. The MBR system is activated by a pressure differential sensor, which detects the buildup of pressure that occurs when particulate matter larger than 10 microns begins to accumulate in the reactor. This pressure differential ensures that particulate matter, which could hinder nutrient recovery or clog filtration systems, is immediately segregated from the liquid effluent.

The MBR system uses specialized membranes with pore sizes designed to selectively filter out larger particles, enabling the recovery of dissolved compounds such as nitrogen, phosphorus, and potassium. These nutrients are essential for plant growth and are recovered from the effluent and redirected into the dual-channel nutrient delivery system. By focusing on the selective recovery of essential nutrients, this system significantly enhances the efficiency of resource use, reduces the need for external fertilizer input, and minimizes waste.

The rainwater harvesting system is another critical component of the system, ensuring the sustainability of water usage within the vertical farming setup. Piezoelectric sensors are embedded within the collection surfaces (such as roof panels or drainage channels) to detect rainfall intensity. These sensors detect when rainfall exceeds a threshold of 2 mm per hour, triggering the activation of the rainwater collection system. This system ensures that water is efficiently harvested during rainfall events, avoiding runoff and maximizing water conservation.

Once the rainwater is collected, it passes through an ultrafiltration membrane for purification. The filtration process is controlled by an embedded UV-LED array that provides photocatalytic sterilization. The activation of this sterilization process is triggered when the sensors detect bacterial contamination exceeding 100 colony-forming units per milliliter in the collected rainwater. This threshold ensures that any potentially harmful microorganisms are neutralized before the water is directed into the irrigation system.

In an embodiment, activation of the servo-motor is triggered by a light intensity threshold of 700 μmol/m²/s, sensed by integrated spectrometers, to modulate shading and light exposure dynamically; real-time adjustments are synchronized with a machine-learning model trained on crop-specific photosynthetic requirements, optimizing light distribution across cultivation trays; and excess heat captured by the canopy panels is dissipated via integrated thermoelectric coolers, maintaining an ambient temperature within ±2° C. of the crop-specific ideal, and wherein hydraulic connections are triggered by an automated docking protocol, initiated upon alignment verification via LiDAR sensors, which activate pneumatically actuated seals to form watertight connections; and enable fluid transfer upon achieving a pressure equilibrium detected by embedded piezoresistive transducers.

In an embodiment, the system uses integrated spectrometers to continuously monitor light intensity at the crop canopy level. When the light intensity reaches a predefined threshold of 700 μmol/m²/s—indicating that the light intensity is sufficient for photosynthesis but may potentially overheat the crops—the servo-motor is triggered to adjust the shading and light exposure dynamically. This threshold is critical in maintaining optimal light levels for plant growth without causing damage due to excess light or heat.

The servo-motor operates as part of the canopy adjustment system, where it modulates the position of adjustable shading panels or canopy elements to optimize light distribution across the cultivation trays. The adjustments are made in real-time based on the light intensity data received from the spectrometers. By using this data-driven approach, the system ensures that each crop receives the right amount of light at all times, preventing light stress and ensuring healthy growth.

The adjustments made by the servo-motor are not purely based on light intensity thresholds; they are synchronized with a machine-learning model that is specifically trained on the photosynthetic requirements of the crops being grown. The model considers factors such as crop species, growth stage, and environmental conditions to predict and optimize the ideal light distribution across the cultivation trays. By leveraging this model, the system can make highly accurate predictions about the light requirements of each crop, ensuring that each plant receives the precise amount of light necessary for photosynthesis, thereby optimizing crop yield and health.

The machine-learning model continuously updates based on data from environmental sensors, including light intensity, temperature, humidity, and crop-specific growth indicators. This adaptive learning process enables the system to adjust dynamically to varying environmental conditions, ensuring that the light exposure is always tailored to the needs of the crops at any given moment.

In addition to regulating light exposure, the system also addresses the heat generated by the canopy panels under high light intensity conditions. Excess heat that is captured by the panels is dissipated using integrated thermoelectric coolers. These coolers work by transferring heat from the canopy panels to a heat sink, cooling the panels to maintain an ambient temperature that is within ±2° C. of the crop-specific ideal temperature range.

The temperature regulation ensures that crops do not experience thermal stress, which could negatively impact growth or yield. By utilizing thermoelectric coolers, the system can maintain precise temperature control without the need for large-scale refrigeration or air-conditioning systems, reducing the overall energy consumption and improving the system's energy efficiency.

The system also includes an advanced automated hydraulic docking mechanism, designed to handle the integration of fluidic connections between multiple modules of the vertical farming system. The docking process is triggered by an automated protocol that relies on alignment verification performed by LiDAR sensors. These sensors scan and verify the precise alignment of each module to ensure that the fluid transfer connections are correctly positioned.

Once the alignment is verified, pneumatically actuated seals are engaged to form watertight hydraulic connections between the modules. This ensures that no leaks occur during fluid transfer. The system's fluid transfer capabilities are further optimized by the use of embedded piezoresistive transducers, which detect pressure equilibrium within the connected modules. When the pressure balance is achieved, the system automatically activates the transfer of water or nutrient solution between modules, enabling seamless fluid movement for irrigation, nutrient delivery, or other operational needs.

The piezoresistive transducers are sensitive to changes in pressure and provide real-time data to the system's control unit, ensuring that fluid movement occurs only when conditions are optimal for efficient transfer. This process is crucial in maintaining a stable and reliable fluid distribution system across the entire farming setup, minimizing energy consumption and water waste.

In an embodiment, irrigation is triggered by a humidity threshold below 60% at the plant canopy level, sensed by MEMS hygrometers; nozzles release nutrient-rich mist in atomized droplets of 10-20 microns diameter for optimized hydroponic absorption rates; and excess mist is recaptured through a condensation system integrated into the tray structure, returning the recovered water to the recycling subsystem, and wherein fluid movement in said micro-channels is triggered by differential pressure sensors detecting flow rates below 1 litre per minute, flow is regulated through micro-pumps operating on pulse-width modulation for precision control; and water returned from the cultivation trays is routed through a heat-exchange system to maintain the temperature of recirculating water within ±3° C. of ambient conditions, optimizing hydroponic growth rates.

The system utilizes MEMS hygrometers embedded within the plant canopy to continuously monitor humidity levels. When the humidity level drops below a predefined threshold of 60%, indicating that the plants are nearing dehydration or in need of supplemental moisture, the irrigation system is triggered. This ensures that the plants receive water only when necessary, optimizing water usage and preventing over-irrigation, which is especially crucial in hydroponic systems where water is a limited resource.

This threshold-based activation ensures the system's efficiency by reducing unnecessary irrigation cycles and providing moisture to the plants only when required, based on real-time environmental data. By utilizing MEMS hygrometers, the system can measure humidity levels with high precision and react to changes in real-time, ensuring that the plants' moisture needs are met efficiently.

Once the irrigation system is triggered, it activates nozzles that release nutrient-rich mist in atomized droplets with a diameter ranging from 10 to 20 microns. This fine mist is designed for optimized hydroponic absorption rates. The small droplet size enhances surface area and allows for more efficient nutrient uptake by the plant roots, as the mist is easily absorbed by the roots in hydroponic environments.

The nutrient solution contained within the mist is composed of essential plant nutrients dissolved in water, and this mist is delivered directly to the root zones of the plants. This method of irrigation is particularly beneficial in hydroponic systems, as it promotes faster nutrient absorption and healthier plant growth by providing a consistent, controlled supply of water and nutrients in a form that is easily absorbed by the plants.

The condensation system ensures that the water vapor, which would otherwise escape into the atmosphere, is efficiently recovered and reintroduced into the system, further conserving water. This closed-loop system not only maximizes water efficiency but also ensures that the nutrients in the mist are effectively recycled, providing a continuous nutrient supply for the plants.

In addition to the irrigation system, fluid movement within the micro-channels of the modular framework is critical to ensure the even distribution of nutrients and water throughout the entire system. The micro-channels, integrated within the load-bearing beams of the framework, are equipped with differential pressure sensors that monitor the flow rates of the nutrient solution or water.

When the flow rate drops below a set threshold of 1 litre per minute, signaling that the fluid flow is insufficient for proper irrigation or nutrient delivery, the differential pressure sensors trigger the operation of micro-pumps. These pumps use pulse-width modulation (PWM) to precisely control the flow of the fluid through the channels. The use of PWM allows for very fine control of the flow rate, ensuring that the system delivers the correct amount of water or nutrient solution to each section of the system, maintaining optimal hydration and nutrient levels.

The system also integrates a heat-exchange system that regulates the temperature of recirculating water to maintain it within ±3° C. of ambient conditions. This temperature regulation is essential in hydroponic systems because fluctuations in water temperature can have significant effects on nutrient absorption and plant growth rates. Water that is too warm or too cold can impair nutrient uptake and hinder optimal plant growth.

The heat-exchange system works by transferring heat between the recirculating water and a cooling or heating source, ensuring that the temperature of the water remains within the ideal range for plant growth. This system operates dynamically to maintain stable water temperatures, providing a more consistent growing environment for the plants, which in turn optimizes hydroponic growth rates.

In an embodiment, the motorized actuators adjust the growing tray angles based on light intensity feedback provided by optical sensors positioned at various points above the trays, and wherein, when the light intensity detected by the sensors is lower than the required threshold, the growing tray angle is automatically adjusted to a steeper position to maximize light exposure to the crops, and when the light intensity is excessive, the system adjusts the trays to a shallower angle, reducing light exposure to prevent light stress, thus maintaining optimal lighting conditions for crop health.

In an embodiment, when the light intensity detected by the sensors is lower than a predefined optimal threshold, indicating that the crops are not receiving sufficient light for photosynthesis, the motorized actuators automatically adjust the angle of the growing trays to a steeper position. The steeper angle allows the crops to receive more light, thereby improving their exposure to the photosynthetic radiation required for healthy growth. By tilting the trays more directly toward the light source, the system maximizes light absorption, promoting healthy crop development.

On the other hand, when the light intensity exceeds the threshold, indicating that the crops might be at risk of light stress or damage (such as from excessive UV exposure), the system automatically adjusts the trays to a shallower angle. This reduces the amount of light that reaches the crops, thereby preventing potential photodamage. By reducing the exposure, the system protects the crops while maintaining an optimal light condition for healthy growth.

The ability of the system to automatically adjust the growing tray angles ensures that crops receive the ideal light conditions throughout the day, enhancing both their growth rates and overall health. This dynamic adjustment is driven by the feedback from the optical sensors, ensuring that the growing environment is continuously optimized based on real-time data.

In an embodiment, each growing tray is independently adjustable, such that trays containing crops at different growth stages are tilted independently based on their specific light requirements, and wherein the system's control module accounts for both the individual growth stages of the crops and the overall light distribution across the entire canopy, adjusting each tray's angle to achieve uniform light exposure across the entire vertical farming structure, allowing for maximum crop productivity and health, with each tray's angle being continuously fine-tuned to the crop's developmental needs, and wherein the canopy adjustment system is integrated with a climate control subsystem, and when the ambient temperature or humidity deviates from the ideal range for plant growth, the growing trays are adjusted to optimize air circulation by repositioning the trays.

The system's control module is capable of evaluating both the light conditions and the growth stages of the crops. Based on this information, it adjusts each growing tray's angle to achieve uniform light exposure across the entire structure. For example, trays with younger plants that require higher light intensities may be positioned at steeper angles, while trays with mature plants that require less direct light may be adjusted to a shallower angle. This allows for fine-tuning of the system to achieve uniform light distribution across the vertical farming structure.

In addition to this, the system also takes into account the overall light distribution across the entire canopy, ensuring that all plants, regardless of their position within the structure, receive the optimal amount of light. This fine-tuned control ensures maximum crop productivity and health. Furthermore, the system continuously monitors and adjusts the angle of each tray to meet the developmental needs of the crops at different stages, supporting their dynamic growth.

Moreover, the canopy adjustment system is integrated with a climate control subsystem. This integration ensures that environmental factors such as temperature and humidity are also considered when adjusting the tray angles. If the ambient temperature or humidity deviates from the ideal range for the crops, the system can reposition the trays to optimize air circulation and maintain a more stable growing environment. For example, if the temperature becomes too high or humidity too low, the trays may be adjusted to allow for better airflow around the crops, preventing heat stress and promoting better transpiration rates. By ensuring that both light exposure and environmental conditions are continuously optimized, the system ensures that the crops receive the best possible growing conditions at every stage of their development. This integration of light management and climate control ensures that the crops remain healthy and productive, improving both the efficiency and sustainability of the vertical farming system.

In an embodiment, the growing trays are positioned on vertical tracks that allow for both horizontal and vertical adjustment of the trays in addition to their angle, such that the system adjusts the vertical position of the trays depending on the size of the crops, and horizontally repositions the trays to optimize space utilization, while simultaneously adjusting the angles to maintain appropriate light levels, allowing for maximum flexibility and adaptation as the crops mature, and wherein the angle of the growing trays is adjusted based on the light absorption needs of each crop, wherein the trays are automatically tilted and repositioned based on real-time measurements of light levels and plant health, with the tray angles being optimized by continuously tracking the growth patterns of the plants, adjusting the tilt in small increments based on changes in the plant's growth stage and its light absorption requirements.

In an embodiment, the trays can be vertically adjusted depending on the size of the crops. As the plants grow taller, the trays can be moved upward to ensure that each plant has enough space to develop without interfering with neighboring crops. This vertical adjustment optimizes the use of the growing space, allowing the system to make the best use of limited space in vertical farming. Conversely, when crops are smaller, the trays can be moved closer together, maximizing the density of crops in the same vertical space.

Additionally, the system allows for horizontal repositioning of the trays. This horizontal movement enables better space management and crop distribution, allowing the system to adapt the positioning of the trays to optimize space and ensure the best possible growth conditions. The trays can be repositioned to optimize the light exposure for each crop, ensuring that each plant receives the ideal amount of light for photosynthesis, even as other plants around them may cast shadows or change their light needs as they grow.

In combination with vertical and horizontal repositioning, the system also adjusts the angles of the trays to ensure that each crop receives appropriate light levels. This angle adjustment is achieved based on real-time measurements of light levels and plant health. Sensors embedded in the system continuously track the intensity of light that reaches the crops and adjust the angle of the trays accordingly. If light intensity is too low or too high, the trays are tilted to an optimal angle to either maximize light exposure or protect the crops from excessive light stress.

The tray angles are adjusted in small increments, ensuring that the system can adapt to the gradual changes in the plant's growth stages and their light absorption needs. By continuously tracking the growth patterns and health of the crops, the system ensures that the angle adjustments are synchronized with the plant's specific requirements, allowing for efficient light use and optimal growth conditions.

This flexible and adaptive system enables maximum crop productivity by ensuring that each crop receives the optimal light conditions, space, and environment needed for healthy growth, while also ensuring that the vertical farming system's space is used as efficiently as possible.

In an embodiment, the capillary-driven wick layer is configured to absorb and distribute nutrient solution evenly across the cultivation platform's surface (512), with the nutrient solution being uniformly drawn from the reservoir channels that distribute water across all layers, and wherein the pressurized irrigation manifold is equipped with a network of micro-diffusers that apply a consistent flow of recycled water directly to the root zones of plants, and wherein the multi-layered cultivation platforms (512) are designed for automated control, with each platform independently monitored for moisture levels via integrated sensors that track water absorption and nutrient uptake, and wherein these sensors communicate with the irrigation system to adjust the flow of pressurized irrigation and the capillary wicks, ensuring that the moisture content in each platform is maintained at an ideal level for plant growth and ensuring that nutrient delivery is optimized across all levels of the stacked system.

The capillary-driven wick layer is designed to absorb and distribute nutrient solution evenly across the surface of each cultivation platform. This layer works by drawing nutrient solution from reservoir channels that are built into the structure of the platform. The capillary action ensures that moisture is spread evenly across the surface, promoting uniform water and nutrient distribution, which is crucial for maintaining plant health.

The pressurized irrigation manifold, equipped with a network of micro-diffusers, works in conjunction with the wick layer. The micro-diffusers are strategically placed to deliver a consistent flow of recycled water directly to the root zones of the plants. This pressurized system ensures that water is applied precisely where it is needed, improving the efficiency of water use and preventing overwatering or underwatering. The use of micro-diffusers ensures that the water is distributed in small, controlled droplets, minimizing evaporation and maximizing absorption by the plant roots.

The multi-layered cultivation platforms are designed for automated control. Each platform is independently monitored for moisture levels via integrated sensors, which track both water absorption and nutrient uptake. These sensors provide real-time data about the moisture content in the platform and the plants' nutrient absorption rates. The sensors communicate with the irrigation system, which adjusts the flow of both the capillary wicks and the pressurized irrigation manifold to ensure that the moisture content in each platform is maintained at an optimal level for plant growth.

For example, when the moisture levels drop below the ideal range for plant growth, the irrigation system increases the flow of water through the capillary wicks and the pressurized manifold to replenish the moisture. Conversely, when the moisture levels are too high, the system can reduce the water flow or activate a drainage mechanism to prevent overwatering. By continuously adjusting the water and nutrient delivery to each platform, the system ensures that the conditions in the growing environment are ideal for plant health and productivity.

The integration of sensors, capillary-driven wicks, and pressurized irrigation manifolds allows for efficient use of water and nutrients while maintaining a healthy growing environment for the crops. This system minimizes waste and maximizes the growth potential of each plant, improving the overall efficiency and sustainability of the vertical farming operation.

In an embodiment, the plurality of robotic precision nozzles perform micro-mist irrigation by atomizing water and nutrient solutions into fine droplets, allowing for precise delivery of moisture to individual plants with minimal water loss, and wherein the system is controlled by automated feedback loops that adjust the operation of the nozzles based on real-time moisture sensors embedded within the growing platforms to ensure that each plant receives an optimal amount of water and nutrients for growth; wherein the robotic precision nozzles are positioned on an adjustable track system, enabling the nozzles to move dynamically over each cultivation platform to provide uniform misting coverage across all plants, with the track system incorporating automated control that coordinates the movement of the nozzles with the growth stage of the crops, ensuring targeted irrigation based on the specific needs of each plant; and wherein the gantry-mounted robotic arm is connected to a central control unit, which processes data from both LiDAR and machine vision systems, allowing the robotic arm to make autonomous decisions on pruning tasks and crop inspections by using machine learning to interpret crop health and environmental conditions, adjusting actions including pruning speed, frequency, and extent based on the evolving needs of the crops.

The system incorporates automated feedback loops that adjust the operation of the nozzles based on real-time moisture sensors embedded within the growing platforms. These moisture sensors continuously monitor the hydration levels of the plants, and when the system detects that moisture levels have dropped below an optimal threshold, it triggers the precision nozzles to atomize water and nutrient solution, ensuring that each plant receives the necessary moisture for growth. These sensors also prevent over-irrigation by shutting off the nozzles or reducing their operation when optimal moisture levels are detected, ensuring efficient water and nutrient use.

The robotic precision nozzles are mounted on an adjustable track system, which allows them to move dynamically over each cultivation platform to provide uniform misting coverage across all plants. The track system is designed for automated control, enabling the nozzles to follow a path over the entire growing area. The movement of the nozzles is synchronized with the growth stage of the crops, ensuring that the irrigation is tailored to the specific needs of each plant. For example, young plants with smaller root systems may require more frequent, light irrigation, while mature plants may need larger, less frequent irrigation bursts. This adaptability optimizes the irrigation process and promotes healthy plant growth.

In addition to the micro-mist irrigation system, the system includes a gantry-mounted robotic arm, which is connected to a central control unit. The robotic arm is equipped with LiDAR (Light Detection and Ranging) and machine vision systems, which enable it to assess crop health and environmental conditions. These systems allow the robotic arm to make autonomous decisions about pruning and crop inspection tasks. Using machine learning algorithms, the system analyzes real-time data to interpret the plant's health status and the environmental conditions in the vertical farming environment. Based on this data, the robotic arm adjusts its actions, including pruning speed, frequency, and extent, to ensure that each crop is cared for optimally. This level of automation helps reduce human labor and ensures that crops receive consistent, precise care tailored to their needs.

In an embodiment, the rotary coupling (534) configured to be connected to a water flow path within the system, wherein the coupling includes one or more micro-turbines that are positioned in line with the excess water flow, such that when water moves through the system during irrigation or nutrient delivery, the kinetic energy from the moving water is transferred to the micro-turbines, causing them to rotate; the rotation of the micro-turbines being mechanically linked to a generator or power conversion unit, wherein the rotating motion is converted into electrical energy, which is routed to a power storage unit or directly to subsystems that require power.

In an embodiment, the rotary coupling is strategically positioned along the water flow path, ensuring that it is in line with the flow of excess water as it moves through the system. When water flows through the system, whether during irrigation or nutrient delivery, the kinetic energy from the moving water is transferred to the micro-turbines. These turbines, due to the force of the moving water, begin to rotate. The rotation of the turbines is mechanically linked to a generator or power conversion unit, which converts the rotational energy into electrical energy.

The electrical energy generated by the micro-turbines is then routed to a power storage unit, such as a battery, or directly to subsystems within the farming system that require power. This could include powering sensors, robotic arms, the micro-mist irrigation system, or other system components that rely on electrical energy for operation. This energy generation mechanism is particularly beneficial for creating a more energy-efficient farming system, as it utilizes the otherwise wasted kinetic energy from water flow to power various subsystems, reducing reliance on external power sources and enhancing the sustainability of the system.

In an agricultural setting, where water flow is integral to irrigation and nutrient delivery, harnessing the kinetic energy from this flow presents a practical solution for enhancing energy efficiency. The integration of micro-turbines within the water flow path not only reduces energy consumption but also contributes to the overall sustainability of the system by generating renewable energy directly from the operation of the system.

In an embodiment, the modular quick-lock mechanism (532) is equipped with automated sensors that continuously monitor the seal integrity of each hydraulic connection and initiate automatic maintenance routines if any leaks are detected, ensuring that the system remains fully operational and leak-proof during continuous use, and wherein the rotary coupling with micro-turbines is designed to be easily detachable for maintenance, with the turbines generating electrical power in addition to mechanical energy.

In an embodiment, the modular quick-lock mechanism that is used to connect the farming modules is equipped with automated sensors that continuously monitor the integrity of each hydraulic connection. These sensors are designed to detect any leakage within the hydraulic seals. Hydraulic connections are critical in systems where fluids such as irrigation water, nutrient solutions, or even wastewater are being transported between modules. If there is any breach or leakage in these connections, it could lead to inefficiency, waste of resources, or system malfunctions The automated sensors embedded in the quick-lock mechanism are continuously monitoring the status of these seals. These sensors detect any abnormal variations in pressure or fluid loss that could indicate a leak. Upon detecting such a leak, the system is programmed to initiate automatic maintenance routines. These routines may include notifying the operator of the detected issue or triggering automatic repair protocols to fix the leak without manual intervention.

Furthermore, the rotary coupling with micro-turbines is designed for easy detachment for maintenance purposes. The micro-turbines within the rotary coupling generate mechanical energy from the flow of excess water, and this energy is converted into electrical power. The turbines, through their operation, help power various subsystems of the system, including sensors and automated mechanisms. The coupling is engineered to be easily detachable, meaning that the turbines can be serviced or replaced without needing to dismantle significant portions of the system. This feature contributes to ease of maintenance, allowing the system to continue operating efficiently while minimizing downtime for repairs.

In an embodiment, the nutrient delivery system (514) monitors real-time crop growth data, including leaf size, stem thickness, and root zone moisture, and adjusts the flow of nutrient solution to each individual cultivation tray by sensing variations in plant growth, dynamically adjusting nutrient delivery rates based on plant responses, wherein the system continuously tracks the effect of nutrient supply on plant development and iterates to maintain optimal growth conditions by adjusting nutrient flows in response to observed growth trends.

In an embodiment, the nutrient delivery system uses sensors embedded within the growing trays or in proximity to the plant roots to monitor these critical growth indicators. For instance, the leaf size and stem thickness can provide valuable information regarding the plant's overall health and its nutrient requirements. Larger leaves and thicker stems often indicate that the plant is in a stage where it requires more nutrients to support continued growth, while smaller leaves and thinner stems may suggest that the plant is in an earlier growth stage or under less stress and therefore needs fewer nutrients. Similarly, root zone moisture is a critical factor in maintaining optimal growing conditions. Plants with well-hydrated root zones are more likely to efficiently absorb nutrients, while plants experiencing moisture stress require immediate adjustments to maintain hydration and nutrient uptake.

The system dynamically adjusts the nutrient delivery rates to each tray based on the data gathered from these sensors. When the system detects that a plant's growth parameters indicate a need for more or fewer nutrients, it adjusts the flow of the nutrient solution accordingly. For example, if the system detects that a plant is experiencing accelerated growth (indicated by increased leaf size or stem thickness), it will increase the nutrient delivery rate to meet the plant's enhanced demands. Conversely, if growth slows or the plant enters a phase where fewer nutrients are needed, the system reduces the nutrient flow to optimize resource use and prevent over-fertilization.

The nutrient delivery system continuously tracks the effects of the nutrient supply on plant development by comparing current growth trends with previous observations. Using this feedback, the system can iterate on its nutrient delivery strategies to maintain optimal growth conditions. This dynamic nutrient management ensures that each plant receives the right amount of nutrients at the right time, leading to improved plant health, faster growth, and higher yields. By incorporating real-time monitoring and dynamic adjustment based on plant responses, this system is able to optimize nutrient use and plant growth without manual intervention. It also helps prevent over-or under-fertilization, reducing waste and ensuring that the crops receive precisely what they need to thrive.

In an embodiment, the stored rainwater undergoes pH balancing and mineral supplementation before being pumped into the hydroponic system, wherein a pH sensor continuously monitors the pH level of the rainwater, and when the pH level falls outside the desired range, a controlled release mechanism adds a pH adjusting solution from a storage reservoir, ensuring that the rainwater is adjusted to meet the optimal nutrient absorption requirements of the crops, with the system automatically detecting and compensating for any changes in water composition due to prolonged storage or external factors.

In an embodiment, the system includes a pH sensor that continuously monitors the pH levels of the stored rainwater. pH is a critical factor in the efficiency of nutrient absorption in hydroponic systems; if the pH is too high or too low, plants may have difficulty absorbing essential nutrients, even if those nutrients are present in the water. The pH sensor ensures that the water is kept within the optimal pH range for plant growth, typically between 5.5 and 6.5 for most hydroponic crops. If the pH level falls outside the desired range, the system automatically detects this deviation and triggers a controlled release mechanism that adds a pH adjusting solution from a storage reservoir. This solution typically contains acids or bases that adjust the water pH back into the optimal range for nutrient absorption.

In addition to pH balancing, mineral supplementation is also crucial for optimal plant growth. Over time, the stored rainwater may lose some of its mineral content or may not have the right levels of minerals needed for the crops in the hydroponic system. To address this, the system ensures that the water is supplemented with the necessary minerals before being used for irrigation. This supplementation ensures that plants receive all the essential elements for growth, such as nitrogen, phosphorus, potassium, calcium, and magnesium, which are vital for healthy plant development.

The system automatically detects and compensates for changes in water composition due to prolonged storage or external factors such as evaporation or contamination. This ensures that the rainwater is always at an ideal composition and pH level when it enters the hydroponic system, facilitating optimal nutrient absorption for the plants.

This feature enhances the precision and consistency of the nutrient solution provided to the crops, reducing the risk of pH imbalances or deficiencies in essential minerals. It also ensures the system can respond dynamically to changes in the stored rainwater, ensuring stable and healthy plant growth throughout varying environmental conditions.

In an embodiment, wastewater from plant irrigation and excess water from the system are captured by an underfloor drainage network that directs the wastewater into a central filtration chamber, where said excess water is filtered using a combination of sand and bio-filtration techniques that remove organic particulates and dissolved salts, and the treated water is then recycled back into the rainwater collection system, further enhancing the overall water efficiency of the farming operation, and wherein the system ensures a closed-loop water cycle, minimizing water wastage by continuously reusing water within the system, and wherein the filtration chamber includes microbial biofilters that use naturally occurring microorganisms to break down organic compounds and neutralize harmful pathogens in the wastewater, ensuring that all recycled water is free from contaminants before being reintroduced into the farming system, with the microbial activity being monitored and adjusted based on the flow rate and water quality.

The wastewater and excess water produced during plant irrigation are collected via an underfloor drainage network. This network is designed to capture all excess water that is not absorbed by the plants, including runoff, and direct it toward a central filtration chamber. The filtration chamber plays a critical role in ensuring that the water can be safely reintroduced into the system after treatment.

Inside the filtration chamber, the excess water undergoes filtration using a combination of techniques. The first level of filtration is accomplished through sand filtration, which removes larger organic particulates, such as plant debris, dirt, or dust, from the water. Sand filtration is effective at removing these particles due to the granular nature of the sand, which acts as a physical filter.

Following the sand filtration stage, the water passes through bio-filtration, where naturally occurring microorganisms (bacteria, fungi, and other microbes) break down organic compounds in the wastewater, such as plant exudates, decaying organic matter, or other biodegradable materials. These microorganisms neutralize harmful pathogens and organic contaminants in the water, ensuring that the water is purified and safe to reuse.

Additionally, the filtration chamber is equipped with microbial biofilters that play a key role in removing harmful pathogens and breaking down complex organic compounds that could negatively affect plant health. The microbial activity is carefully monitored and adjusted to maintain effective filtration. This includes tracking the flow rate of the water and ensuring that microbial populations are properly managed to keep the filtration process efficient. In the event of changes in water quality, the system can adjust the conditions in the filtration chamber to maintain optimal microbial performance.

Once the water has been filtered, it is recycled back into the rainwater collection system, where it can be used again for irrigation. This process contributes to a closed-loop water cycle, minimizing water wastage and promoting sustainability. By continually reusing water within the system, the need for external water inputs is drastically reduced, resulting in a water-efficient farming operation that conserves resources while ensuring the crops receive the necessary hydration. This closed-loop system provides several benefits. Firstly, it reduces the consumption of freshwater by continuously recirculating treated water. Secondly, it reduces the environmental impact of wastewater by ensuring that harmful chemicals, salts, and pathogens do not enter the ecosystem. Finally, it provides cost savings by minimizing the need for external water sources, making it an environmentally and economically sustainable solution for vertical farming.

In an embodiment, the modular mechanical framework (502) is designed with adjustable tensioning cables integrated within the beams, which actively modify their load distribution in response to detected strain from piezoelectric sensors, thereby dynamically optimizing the structural integrity of the framework during operational cycles and enhancing the system's resilience against external forces including wind, seismic activity, and varying mechanical loads, and wherein the retractable rail system further comprises a motorized adjustment mechanism that dynamically alters the length of the rails based on operational requirements, enabling the system to scale up or down depending on the crop density and growth phase.

In an embodiment, the modular mechanical framework of the system includes adjustable tensioning cables integrated within the beams of the structure. These tensioning cables are designed to actively modify the load distribution of the framework in response to strain detected by piezoelectric sensors embedded in the beams. Piezoelectric sensors detect dynamic strain caused by external forces, such as wind, seismic activity, or varying mechanical loads. These sensors send real-time data to the control system, which processes the strain information to adjust the tension in the cables. The adjustment of the tensioning cables dynamically optimizes the load distribution across the beams, ensuring that the framework maintains structural integrity under varying operational conditions. For example, when the system detects external forces like wind or seismic activity, the cables can automatically tighten or loosen to distribute the loads more effectively, ensuring the structure remains stable. This system significantly enhances the resilience of the farming structure, ensuring it can withstand external forces while maintaining safe operational conditions for the crops.

The use of piezoelectric sensors also enables the framework to be self-adjusting, as the system continuously monitors and reacts to the changing mechanical environment, ensuring optimal load-bearing performance throughout different operational cycles.

In an embodiment, the retractable rail system is designed to provide flexibility in scaling the farming system according to the crop density and growth phase. The rail system includes a motorized adjustment mechanism that dynamically alters the length of the rails. This motorized mechanism is controlled based on the operational requirements of the system, such as the density of crops or their growth phase. During different crop growth stages, the length of the rails can be adjusted to optimize maintenance and harvesting operations. For example, when crops are in their early growth phase with lower density, the rails can be contracted to reduce the travel distance for the robotic tools. As crops mature and the density increases, the rails can be extended to accommodate the expanded operational needs.

The retractable rail system's ability to scale up or down based on crop requirements ensures that the system remains efficient and adaptive, supporting varied crop types and densities across multiple growth stages. This system improves the flexibility of the farming operation, allowing it to be fine-tuned for maximum crop productivity and ease of maintenance.

In an embodiment, the dual-channel nutrient delivery system (514) incorporates a flow-rate monitoring subsystem, which continuously adjusts the nutrient solution delivery rates in real-time based on feedback from flow sensors embedded in the irrigation channels, optimizing fluid dynamics and ensuring that each plant receives the precise amount of nutrients required for optimal growth without over-saturation or under-nourishment.

In an embodiment, the dual-channel nutrient delivery system incorporates flow sensors embedded in the irrigation channels that measure the flow rate of the nutrient solution. These flow sensors provide continuous, real-time data on the amount of nutrient solution passing through each channel. This data is then fed into the system's control unit, which dynamically adjusts the flow rates of the nutrient solution to ensure optimal delivery for each plant.

The flow-rate monitoring system enables the precise adjustment of nutrient delivery, ensuring that each plant receives the ideal amount of nutrients based on its growth needs. This prevents both over-saturation (which could lead to nutrient imbalances or waterlogging) and under-nourishment (which could lead to nutrient deficiencies and suboptimal growth). By optimizing the flow of nutrients, the system promotes uniform crop health across the entire vertical farm.

In addition to nutrient delivery, the flow-rate monitoring subsystem also helps maintain fluid dynamics in the system, ensuring that the nutrient solution moves smoothly and efficiently through the channels. This system is particularly important in maintaining steady nutrient absorption in hydroponic systems, where any fluctuation in water or nutrient delivery can have a direct impact on crop performance.

The continuous monitoring and adjustment of the nutrient flow also enhances the precision farming aspect of the system, ensuring that each plant's unique requirements are met with minimal waste of resources. This system improves sustainability by optimizing resource usage, reducing the need for manual intervention, and ensuring that the plants receive the right amount of nutrients for their developmental stage.

In an embodiment, the automated control system governing the movement of the robotic precision nozzles dynamically calculates and adjusts the movement path of the nozzles in real-time, based on the varying geometries and growth patterns of the plants on each cultivation platform, wherein the automated control system utilizes spatial data gathered from the system's integrated machine vision and LiDAR sensors to map the positions and dimensions of individual plants, including those in irregular crop layouts, and wherein the automated control system is further configured to accommodate irregularities in plant spacing and growth stage by continuously recalculating the most efficient coverage path, ensuring that nutrient-rich mist is delivered to each plant's root zone with minimal overlap or under-saturation.

In an embodiment, the automated control system governing the robotic precision nozzles dynamically calculates and adjusts the movement path of the nozzles in real-time. The movement of the nozzles is governed by spatial data, which is gathered through machine vision and LiDAR sensors embedded within the system. These sensors map the positions and dimensions of the individual plants, including those in irregular crop layouts. The system is particularly adept at handling irregular plant spacing and variations in plant growth stages. By continuously analyzing and recalculating the most efficient coverage path, the automated control system ensures that the nutrient mist is delivered precisely to the root zone of each plant. This dynamic adjustment minimizes issues such as overlap (which would result in nutrient wastage) or under-saturation (which would lead to inadequate nutrient delivery to the plants).

For example, in a densely planted area where plants are close together, the system can adjust the nozzle path to prevent the mist from spilling over onto neighboring plants or missing any of them due to tight spacing. Similarly, for plants that are growing at different rates or in non-uniform rows, the system recalculates the path to ensure even and sufficient nutrient delivery tailored to each plant's specific growth needs.

The ability of the system to account for these plant geometries and growth patterns ensures that nutrient delivery is optimized, with minimal wastage or inefficiencies. This contributes to precision farming, where each plant's needs are met with minimal intervention.

In an embodiment, the localized decision-making controller includes a network of edge Artificial Intelligence based processors that utilize advanced machine learning algorithms, specifically convolutional neural networks (CNN) for image processing and recurrent neural networks (RNN) for time-series data, to process data locally from various sensors embedded within the system, including environmental sensors selected from a group comprising temperature, humidity, light, CO₂; plant health sensors including leaf color, size, and growth rates, and operational sensors including flow rates, mechanical strain, power consumption, wherein the Artificial Intelligence based processors are trained on a combination of historical crop growth data, environmental conditions, and system performance metrics to continuously monitor and predict crop health, enabling early detection of anomalies, including stress or nutrient deficiencies, and system faults, including pump failures or clogging, wherein the Artificial Intelligence based processors use real-time sensor data to dynamically adjust system parameters including nutrient delivery, irrigation cycles, light exposure, and environmental control settings by generating time-sensitive action plans, optimizing resource use, and ensuring crop health.

In an embodiment, the localized decision-making controller uses a network of edge Artificial Intelligence (AI) processors, which are equipped with advanced machine learning algorithms. These processors handle tasks such as processing time-series data and performing image processing. Specifically, the system utilizes Convolutional Neural Networks (CNN) for analyzing visual data from plant health sensors and Recurrent Neural Networks (RNN) for processing time-series data such as changes in environmental factors (e.g., temperature, humidity, light, CO₂ levels), plant health indicators (e.g., leaf color, size, growth rates), and operational parameters (e.g., flow rates, mechanical strain, power consumption). These processors are trained using a combination of historical crop growth data, environmental conditions, and system performance metrics. They continuously monitor and predict crop health, providing the ability to detect anomalies such as stress or nutrient deficiencies in plants, as well as system faults like pump failures or clogging.

The AI system provides the ability to anticipate and respond to issues before they become critical, enhancing the overall efficiency and sustainability of the farming operation. For example, when the system detects that a plant is showing signs of nutrient deficiency or stress (through sensors tracking growth rates, leaf color, or size), the AI controller can automatically adjust the system's parameters to correct the imbalance-such as by altering nutrient delivery, adjusting irrigation cycles, or modifying light exposure. Similarly, the system can detect operational issues, such as a pump failure or clogging, based on sensor data about flow rates or mechanical strain. Once a fault is detected, the AI can trigger maintenance protocols or alert system operators to take corrective action. These real-time, predictive decisions ensure that the system is self-optimizing, reducing the need for human intervention and minimizing the risk of crop loss due to system failures. The AI processors also generate time-sensitive action plans to optimize resource use, improving efficiency and reducing waste. For example, the system may calculate when to adjust the irrigation cycle based on current weather patterns or the growth stage of crops. This approach enables smart farming where decisions are made based on real-time data, ensuring the crops receive the correct amount of resources (water, nutrients, light) at the right time. Since these AI processors are located on-site, or “edge” computing, the system benefits from low-latency decision-making, meaning that changes in environmental conditions or plant health can be addressed without delays caused by data transmission to remote servers. This localized processing ensures that the system operates efficiently and autonomously, capable of making split-second decisions based on the continuous stream of real-time sensor data.

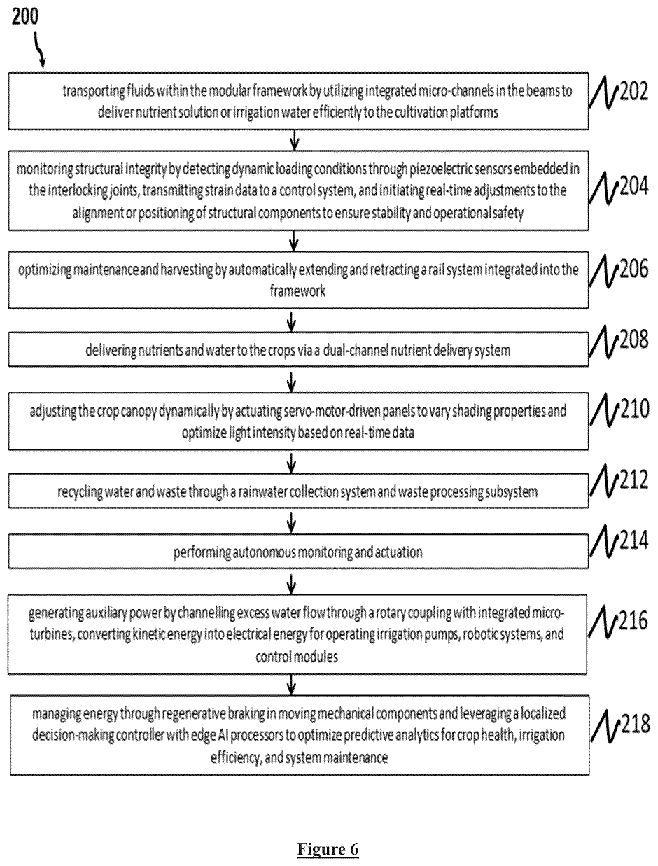

FIG. 6 illustrates a flow chart of a method (200) for operating an intelligent agriculture system incorporating waste and rainwater recycling for vertical farming.

Referring to FIG. 6, the method (200) includes a plurality of steps as described under:

At step (202), the method (200) includes transporting fluids within the modular framework by utilizing integrated micro-channels in the beams to deliver nutrient solution or irrigation water efficiently to the cultivation platforms.

At step (204), the method (200) includes monitoring structural integrity by detecting dynamic loading conditions through piezoelectric sensors embedded in the interlocking joints, transmitting strain data to a control system, and initiating real-time adjustments to the alignment or positioning of structural components to ensure stability and operational safety.

At step (206), the method (200) includes optimizing maintenance and harvesting by automatically extending and retracting a rail system integrated into the framework, wherein the rail system supports robotic or manual tools for performing maintenance, crop monitoring, and harvesting tasks.

At step (208), the method (200) includes delivering nutrients and water to the crops via a dual-channel nutrient delivery system: a capillary-driven wick layer within each cultivation platform for uniform nutrient and moisture distribution; and a pressurized irrigation manifold with micro-diffusers for precisely delivering recycled water directly to the root zones of plants;

At step (210), the method (200) includes adjusting the crop canopy dynamically by actuating servo-motor-driven panels to vary shading properties and optimize light intensity based on real-time data, wherein the angles of growing trays are incrementally adjusted through motorized actuators in response to data from tilt sensors and light intensity sensors to ensure optimal light exposure.

At step (212), the method (200) includes recycling water and waste through: a rainwater collection system incorporating filtration and photocatalytic sterilization to produce purified water for reuse in irrigation; and a waste processing subsystem using anaerobic digestion and membrane bioreactor technology to recover nutrient compounds and reintroduce them into the irrigation system.

At step (214), the method (200) includes performing autonomous monitoring and actuation by: measuring environmental parameters, including nutrient concentrations, fluid flow rates, and atmospheric CO₂ levels, using distributed MEMS sensors; and actuating robotic precision nozzles for micro-mist irrigation and utilizing a gantry-mounted robotic arm equipped with machine vision for pruning, inspection, and maintenance tasks.

At step (216), the method (200) includes generating auxiliary power by channeling excess water flow through a rotary coupling with integrated micro-turbines, converting kinetic energy into electrical energy for operating irrigation pumps, robotic systems, and control modules.

At step (218), the method (200) includes managing energy through regenerative braking in moving mechanical components and leveraging a localized decision-making controller with edge AI processors to optimize predictive analytics for crop health, irrigation efficiency, and system maintenance.

The smart vertical farming system provides a complete and sustainable agricultural solution based on modular infrastructure, advanced water recycling technology, and artificial intelligence automation technology. Addressing the challenges of modern farming with precision and efficiency, their integration ensures optimal resource utilization, heightened productivity, and lessened environmental impact; all while leveraging the potentials of IOT and machine learning.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. An intelligent agriculture system incorporating waste and rainwater recycling for vertical farming, comprising:
a) a modular mechanical framework configured for vertical assembly, each module including:
i. a load-bearing exoskeleton formed having a plurality of beams with integrated micro-channels for internal fluid transport, wherein each beam includes integrated micro-channels for the internal transport of fluids, said micro-channels being capable of carrying nutrient solution or irrigation water to various points within the structure, enabling the efficient delivery of fluids to the crops housed within the module;
ii. a plurality of interlocking joints positioned at key points of the exoskeleton, each joint embedding piezoelectric sensors that detect and measure structural strain during dynamic loading conditions, and wherein the piezoelectric sensors are connected to an automated control system that processes strain data in real-time and adjusts the positioning or alignment of the beams to compensate for dynamic forces, ensuring stability and structural integrity under varying operational loads;
iii. a retractable rail system integrated into the framework, said rail system being automatically extendable along predefined tracks built into the beams, enabling efficient automated maintenance and harvesting operations by providing a mobile platform that supports robotic and manual tools for plant care, monitoring, and harvesting tasks;
b) a stacked cultivation system comprising:
i. multi-layered cultivation platforms, each designed for stacked configuration to maximize vertical space, wherein each platform features a system of integrated channels designed to optimize water flow and prevent stagnation, with each layer acting as an independent cultivation unit capable of receiving uniform light, water, and nutrients through the system, ensuring each plant's root zone is consistently maintained with the optimal moisture levels;
ii. a dual-channel nutrient delivery system within each platform, wherein the first channel is equipped with a capillary-driven wick layer that promotes uniform distribution of nutrients and moisture across the platform's surface, and wherein the second channel incorporates a pressurized irrigation manifold equipped with micro-diffusers strategically placed to precisely deliver recycled water directly to the root zones of plants;
iii. an adaptive canopy adjustment mechanism featuring servo-motor-driven panels with variable shading properties, configured to optimize photosynthetic photon flux density based on real-time crop requirements, wherein the canopy adjustment system comprises a series of motorized actuators mechanically connected to the base of each growing tray, enabling the automatic adjustment of the tray angles to optimize light exposure across the crop canopy, wherein each growing tray is equipped with tilt sensors that detect the current angle and relay this data to the central control module, which calculates the optimal angle for each tray based on real-time data from light intensity sensors and plant growth indicators, and wherein the system adjusts the tray angle by tilting the trays in small incremental movements to ensure that the crops receive the correct light distribution depending on their growth stage and the intensity of light reaching the canopy;
c) an integrated waste and rainwater recycling subsystem, comprising:
i. a hybrid rainwater collection and filtration apparatus with an ultrafiltration membrane incorporating nanostructured titanium dioxide coatings for photocatalytic sterilization;
ii. a waste processing reactor involving anaerobic digestion followed by a membrane bioreactor (MBR) stage to recover and concentrate nutrient compounds, which are reintroduced into the irrigation system via an embedded nutrient dispensing unit;
d) an autonomous monitoring and actuation system, comprising:
i. distributed microelectromechanical systems (MEMS) sensors embedded within the cultivation platforms and structural framework to measure environmental parameters, including nutrient concentration gradients, fluid flow rates, and atmospheric CO₂ levels;
ii. a mechanical actuation subsystem, including a plurality of robotic precision nozzles for micro-mist irrigation and a gantry-mounted robotic arm equipped with LiDAR and machine vision for autonomous pruning, crop inspection, and modular maintenance;
e) a scalable mechanical docking interface for integrating multiple farming modules, wherein each module includes a modular quick-lock mechanism that utilizes pneumatically actuated seals to form leak-proof hydraulic connections between modules, comprising:
i. a modular quick-lock mechanism with pneumatically actuated seals to ensure leak-proof hydraulic connections between modules;
ii. a rotary coupling to generate auxiliary power from excess water flow, facilitating energy-efficient operation of subsystems; and
f) a modular power management and control unit, comprising:
i. a regenerative braking system embedded within moving mechanical components, including canopy panels and robotic arms, to recover kinetic energy;
ii. a localized decision-making controller leveraging edge AI processors to enable predictive analytics for crop health and system maintenance, minimizing latency in autonomous operations.

2. The system of claim 1, wherein the nutrient delivery system is triggered by a feedback loop integrating MEMS sensors measuring real-time root-zone hydration levels and electrochemical nutrient concentration, initiating: a capillary-driven flow from the wick layer upon detection of moisture levels below a predefine optimal threshold; and a pressurized micro-diffuser activation through solenoid valves, dynamically calibrated to deliver nutrient-enriched recycled water in bursts proportional to plant absorption rates.

3. The system of claim 1, wherein the anaerobic digestion stage is triggered by a volumetric sensor detecting organic waste accumulation exceeding 85% of the reactor's capacity, and the subsequent membrane bioreactor (MBR) is activated via a pressure differential sensor, ensuring immediate segregation of particulate matter larger than 10 microns; selective recovery of dissolved nitrogen, phosphorus, and potassium compounds; and automated redirection of concentrated nutrients to the dual-channel nutrient delivery system, and wherein the rainwater harvesting is triggered by piezoelectric sensors embedded in the collection surfaces, detecting rainfall intensity above 2 mm/hour and the ultrafiltration membrane activates a photo catalytic sterilization cycle powered by embedded UV-LED arrays when bacterial counts exceed 100 colony-forming units per millilitre.

4. The system of claim 1, wherein activation of the servo-motor is triggered by a light intensity threshold of 700 μmol/m²/s, sensed by integrated spectrometers, to modulate shading and light exposure dynamically; real-time adjustments are synchronized with a machine-learning model trained on crop-specific photosynthetic requirements, optimizing light distribution across cultivation trays; and excess heat captured by the canopy panels is dissipated via integrated thermoelectric coolers, maintaining an ambient temperature within ±2° C. of the crop-specific ideal, and wherein hydraulic connections are triggered by an automated docking protocol, initiated upon alignment verification via LiDAR sensors, which activate pneumatically actuated seals to form watertight connections; and
enable fluid transfer upon achieving a pressure equilibrium detected by embedded piezoresistive transducers.

5. The system of claim 1, wherein: irrigation is triggered by a humidity threshold below 60% at the plant canopy level, sensed by MEMS hygrometers; nozzles release nutrient-rich mist in atomized droplets of 10-20 microns diameter for optimized hydroponic absorption rates; and excess mist is recaptured through a condensation system integrated into the tray structure, returning the recovered water to the recycling subsystem, and wherein fluid movement in said micro-channels is triggered by differential pressure sensors detecting flow rates below 1 litre per minute, flow is regulated through micro-pumps operating on pulse-width modulation for precision control; and water returned from the cultivation trays is routed through a heat-exchange system to maintain the temperature of recirculating water within ±3° C. of ambient conditions, optimizing hydroponic growth rates.

6. The system of claim 1, wherein the motorized actuators adjust the growing tray angles based on light intensity feedback provided by optical sensors positioned at various points above the trays, and wherein, when the light intensity detected by the sensors is lower than the required threshold, the growing tray angle is automatically adjusted to a steeper position to maximize light exposure to the crops, and when the light intensity is excessive, the system adjusts the trays to a shallower angle, reducing light exposure to prevent light stress, thus maintaining optimal lighting conditions for crop health.

7. The system of claim 1, wherein each growing tray is independently adjustable, such that trays containing crops at different growth stages are tilted independently based on their specific light requirements, and wherein the system's control module accounts for both the individual growth stages of the crops and the overall light distribution across the entire canopy, adjusting each tray's angle to achieve uniform light exposure across the entire vertical farming structure, allowing for maximum crop productivity and health, with each tray's angle being continuously fine-tuned to the crop's developmental needs, and wherein the canopy adjustment system is integrated with a climate control subsystem, and when the ambient temperature or humidity deviates from the ideal range for plant growth, the growing trays are adjusted to optimize air circulation by repositioning the trays.

8. The system of claim 1, wherein the growing trays are positioned on vertical tracks that allow for both horizontal and vertical adjustment of the trays in addition to their angle, such that the system adjusts the vertical position of the trays depending on the size of the crops, and horizontally repositions the trays to optimize space utilization, while simultaneously adjusting the angles to maintain appropriate light levels, allowing for maximum flexibility and adaptation as the crops mature, and wherein the angle of the growing trays is adjusted based on the light absorption needs of each crop, wherein the trays are automatically tilted and repositioned based on real-time measurements of light levels and plant health, with the tray angles being optimized by continuously tracking the growth patterns of the plants, adjusting the tilt in small increments based on changes in the plant's growth stage and its light absorption requirements.

9. The system of claim 1, wherein the capillary-driven wick layer is configured to absorb and distribute nutrient solution evenly across the cultivation platform's surface, with the nutrient solution being uniformly drawn from the reservoir channels that distribute water across all layers, and wherein the pressurized irrigation manifold is equipped with a network of micro-diffusers that apply a consistent flow of recycled water directly to the root zones of plants, and wherein the multi-layered cultivation platforms are designed for automated control, with each platform independently monitored for moisture levels via integrated sensors that track water absorption and nutrient uptake, and wherein these sensors communicate with the irrigation system to adjust the flow of pressurized irrigation and the capillary wicks, ensuring that the moisture content in each platform is maintained at an ideal level for plant growth and ensuring that nutrient delivery is optimized across all levels of the stacked system.

10. The system of claim 1, comprising: wherein the plurality of robotic precision nozzles perform micro-mist irrigation by atomizing water and nutrient solutions into fine droplets, allowing for precise delivery of moisture to individual plants with minimal water loss, and wherein the system is controlled by automated feedback loops that adjust the operation of the nozzles based on real-time moisture sensors embedded within the growing platforms to ensure that each plant receives an optimal amount of water and nutrients for growth; wherein the robotic precision nozzles are positioned on an adjustable track system, enabling the nozzles to move dynamically over each cultivation platform to provide uniform misting coverage across all plants, with the track system incorporating automated control that coordinates the movement of the nozzles with the growth stage of the crops, ensuring targeted irrigation based on the specific needs of each plant; and wherein the gantry-mounted robotic arm is connected to a central control unit, which processes data from both LiDAR and machine vision systems, allowing the robotic arm to make autonomous decisions on pruning tasks and crop inspections by using machine learning to interpret crop health and environmental conditions, adjusting actions including pruning speed, frequency, and extent based on the evolving needs of the crops.

11. The system of claim 1, wherein the rotary coupling configured to be connected to a water flow path within the system, wherein the coupling includes one or more micro-turbines that are positioned in line with the excess water flow, such that when water moves through the system during irrigation or nutrient delivery, the kinetic energy from the moving water is transferred to the micro-turbines, causing them to rotate; the rotation of the micro-turbines being mechanically linked to a generator or power conversion unit, wherein the rotating motion is converted into electrical energy, which is routed to a power storage unit or directly to subsystems that require power.

12. The system of claim 1, wherein the modular quick-lock mechanism is equipped with automated sensors that continuously monitor the seal integrity of each hydraulic connection and initiate automatic maintenance routines if any leaks are detected, ensuring that the system remains fully operational and leak-proof during continuous use, and wherein the rotary coupling with micro-turbines is designed to be easily detachable for maintenance, with the turbines generating electrical power in addition to mechanical energy.

13. The system of claim 1, wherein the nutrient delivery system monitors real-time crop growth data, including leaf size, stem thickness, and root zone moisture, and adjusts the flow of nutrient solution to each individual cultivation tray by sensing variations in plant growth, dynamically adjusting nutrient delivery rates based on plant responses, wherein the system continuously tracks the effect of nutrient supply on plant development and iterates to maintain optimal growth conditions by adjusting nutrient flows in response to observed growth trends.

14. The system of claim 1, wherein the stored rainwater undergoes pH balancing and mineral supplementation before being pumped into the hydroponic system, wherein a pH sensor continuously monitors the pH level of the rainwater, and when the pH level falls outside the desired range, a controlled release mechanism adds a pH adjusting solution from a storage reservoir, ensuring that the rainwater is adjusted to meet the optimal nutrient absorption requirements of the crops, with the system automatically detecting and compensating for any changes in water composition due to prolonged storage or external factors.

15. The system of claim 1, wherein wastewater from plant irrigation and excess water from the system are captured by an underfloor drainage network that directs the wastewater into a central filtration chamber, where said excess water is filtered using a combination of sand and bio-filtration techniques that remove organic particulates and dissolved salts, and the treated water is then recycled back into the rainwater collection system, further enhancing the overall water efficiency of the farming operation, and wherein the system ensures a closed-loop water cycle, minimizing water wastage by continuously reusing water within the system, and wherein the filtration chamber includes microbial biofilters that use naturally occurring microorganisms to break down organic compounds and neutralize harmful pathogens in the wastewater, ensuring that all recycled water is free from contaminants before being reintroduced into the farming system, with the microbial activity being monitored and adjusted based on the flow rate and water quality.

16. The system of claim 1, wherein the modular mechanical framework is designed with adjustable tensioning cables integrated within the beams, which actively modify their load distribution in response to detected strain from piezoelectric sensors, thereby dynamically optimizing the structural integrity of the framework during operational cycles and enhancing the system's resilience against external forces including wind, seismic activity, and varying mechanical loads, and wherein the retractable rail system further comprises a motorized adjustment mechanism that dynamically alters the length of the rails based on operational requirements, enabling the system to scale up or down depending on the crop density and growth phase.

17. The system of claim 1, wherein the dual-channel nutrient delivery system incorporates a flow-rate monitoring subsystem, which continuously adjusts the nutrient solution delivery rates in real-time based on feedback from flow sensors embedded in the irrigation channels, optimizing fluid dynamics and ensuring that each plant receives the precise amount of nutrients required for optimal growth without over-saturation or under-nourishment.

18. The system of claim 1, wherein the automated control system governing the movement of the robotic precision nozzles dynamically calculates and adjusts the movement path of the nozzles in real-time, based on the varying geometries and growth patterns of the plants on each cultivation platform, wherein the automated control system utilizes spatial data gathered from the system's integrated machine vision and LiDAR sensors to map the positions and dimensions of individual plants, including those in irregular crop layouts, and wherein the automated control system is further configured to accommodate irregularities in plant spacing and growth stage by continuously recalculating the most efficient coverage path, ensuring that nutrient-rich mist is delivered to each plant's root zone with minimal overlap or under-saturation.

19. The system of claim 1, wherein the localized decision-making controller includes a network of edge Artificial Intelligence based processors that utilize advanced machine learning algorithms, specifically convolutional neural networks (CNN) for image processing and recurrent neural networks (RNN) for time-series data, to process data locally from various sensors embedded within the system, including environmental sensors selected from a group comprising temperature, humidity, light, CO₂; plant health sensors including leaf color, size, and growth rates, and operational sensors including flow rates, mechanical strain, power consumption, wherein the Artificial Intelligence based processors are trained on a combination of historical crop growth data, environmental conditions, and system performance metrics to continuously monitor and predict crop health, enabling early detection of anomalies, including stress or nutrient deficiencies, and system faults, including pump failures or clogging, wherein the Artificial Intelligence based processors use real-time sensor data to dynamically adjust system parameters including nutrient delivery, irrigation cycles, light exposure, and environmental control settings by generating time-sensitive action plans, optimizing resource use, and ensuring crop health.
